(19) United States
(12) Patent Application Publication
(10) Pub. No.: US 2022/0405691 A1
(43) Pub. Date: Dec. 22, 2022

(54) Electronic Logging Device Exempt Digital Fleet Management Solution

(71) Applicant: Bendix Commercial Vehicle Systems LLC, Avon, OH (US)

(72) Inventors: Larry Nilmeier, Spartanburg, SC (US); William Morgan, Crystal Lake, IL (US); Shaun Howard, Irvine, CA (US)

(21) Appl. No.: 17/834,559

(22) Filed: Jun. 7, 2022

Related U.S. Application Data
(60) Provisional application No. 63/211,068, filed on Jun. 16, 2021.

(51) Int. Cl. G06Q 10/06; G06Q 10/00

(52) U.S. Cl. CPC G06Q 10/063114; G06Q 10/20

(57) ABSTRACT

An electronic logging device exempt digital fleet management solution for short haul trucking fleets to comply with the short haul exception for fleets that are exempt from using Electronic Logging Devices (ELDs) to track their drivers' activities. The solution includes a mobile application for drivers used while on duty to capture their time, location, status, documents, and inspection report data. The data is transmitted and stored in one or more databases accessed by a backend user accesses and compiles additional data collected from the mobile apps to provide fleet users with access and services related to the driver data. The application includes two way messaging between the driver and the backend website user as well as document scanning and upload for items required for bills of lading or the like. The intended users of the invention are commercial trucking fleets or owner/operator fleets that are exempt from using Electronic Logging Devices (ELDs) to track driver activities as mandated by the Federal Motor Carrier Safety Association (PMCSA) under the ELD rule.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### RESERVATION OF RIGHTS

A portion of the disclosure of this patent document contains material which is subject to intellectual property rights such as but not limited to copyright, trademark, and/or trade dress protection. The owner has no objection to the facsimile reproduction by anyone of the patent document or the patent disclosure as it appears in the Patent and Trademark Office patent files or records but otherwise reserves all rights whatsoever.

### BACKGROUND OF THE INVENTION

### 1. Field of the Invention

The present invention relates to improvements in an Electronic Logging Device Exempt Digital Fleet Management Solution. More particularly, the invention relates to improvements particularly suited for providing a mobile application and recording system.

2. Description of the Known Art

As will be appreciated by those skilled in the art, electronic logging devices for use with over the road tractor trailers are known in various forms. Patents disclosing information relevant to electronic logging devices include: U.S. Pat. No. 10,977,604, issued to Berdinis, et al. on Apr. 13, 2021 entitled Systems for routing and controlling vehicles for freight; U.S. Pat. No. 10,956,855, issued to Coughran, et al. on Mar. 23, 2021 entitled Integrated multi-location scheduling, routing, and task management; U.S. Pat. No. 10,896,401, issued to Berdinis, et al. on Jan. 19, 2021 entitled Coordinating shipments on freight vehicles; U.S. Pat. No. 10,776,748, issued to Jones, et al. on Sep. 15, 2020 entitled Communication analysis for obtaining loads; U.S. Pat. No. 10,614,640, issued to Gintz, et al. on Apr. 7, 2020 entitled System and method for real time wireless ECU monitoring and reprogramming; U.S. Pat. No. 10,417,844, issued to Ambrose, et al. on Sep. 17, 2019 entitled Electronic logging device event generator; U.S. Pat. No. 10,373,402, issued to Kwak on Aug. 6, 2019 entitled Commercial driver electronic logging rule compliance and vehicle inspection voice assistant system; U.S. Pat. No. 10,255,606, issued to Harter, et al. on Apr. 9, 2019 entitled Method and system for authenticating a driver for driver compliance; and U.S. Pat. No. 9,685,098, issued to Kypri on Jun. 20, 2017 entitled Driver compliance risk adjustments. Each of these patents is hereby expressly incorporated by reference in their entirety.

Additionally, load tickets are known in the industry. Patents related to load tickets include: U.S. Pat. No. 10,789,560, issued to Mendiola, et al. on Sep. 29, 2020 entitled System for tracking hauling operations; U.S. Pat. No. 6,421,586, issued to Nicotera on Jul. 16, 2002 entitled Vehicle tracking and auditing system and method; U.S. Pat. No. 5,884,238, issued to Noll, et al. on Mar. 16, 1999 entitled Method and structure for properly positioning freight in a trailer, container or other freight receptacle; and U.S. Pat. No. 7,949,612, issued to Davis, III on May 24, 2011 entitled Method and load input device for optimizing log truck productivity. Each of these patents is also hereby expressly incorporated by reference in their entirety.

Patents related to duty day include: U.S. Pat. No. 6,907,410, issued to Chang, et al. on Jun. 14, 2005, entitled Transportation crew dispatch method based on single day business; and U.S. Pat. No. 6,104,282, issued to Fragoso, et al. on Aug. 15, 2000, entitled Daily log device. Each of these patents is again hereby expressly incorporated by reference in their entirety.

The Federal Motor Carrier Safety Administration currently has an Hours of Service Drivers Final Rule as follows:

“FMCSA revises the hours of service (HOS) regulations to provide greater flexibility for drivers subject to those rules without adversely affecting safety. The Agency: (1) expands the short-haul exception to 150 air-miles and allows a 14-hour work shift to take place as part of the exception; (2) expands the driving window during adverse driving conditions by up to an additional 2 hours; (3) requires a 30-minute break after 8 hours of driving time (instead of on-duty time) and allows an on-duty/not driving period to qualify as the required break; and (4) modifies the sleeper berth exception to allow a driver to meet the 10-hour minimum off-duty requirement by spending at least 7, rather than at least 8 hours of that period in the berth and a minimum off-duty period of at least 2 hours spent inside or outside of the berth, provided the two periods total at least 10 hours, and that neither qualifying period counts against the 14-hour driving window.”

This raises issues about to whom do the rules for electronic logging devices (ELD) apply, and who is exempt from using ELDs. FMCSA states:

6.4.4 Driver's Record of Duty Status (RODS) (395.8)

Every driver needs to prepare a record of duty status for each 24-hour period. Failure to record, complete, or retain the log, or knowingly falsifying logs or other reports, makes the driver and/or carrier liable to prosecution. Logs must be kept current by showing each change in duty status. The time zone used on a driver's daily log should be the time standard of that driver's home terminal. See 49 CFR 395.8 for more information.

Short-Haul Exemptions to Record of Duty Status Regulations

There are exceptions to the RODS regulations for drivers that drive short distances:
150 air-mile radius driver exemption (see 49 CFR 395.1 (e)(1)).
150 air-mile radius driver exemption, for drivers of property-carrying CMVs who do not require a CDL and operate within a 150 air-mile radius of their normal work reporting location (see 49 CFR 395.1 (e)(2)).

Drivers must meet all of the qualifications specified in the regulations to use an exemption. If even one of the qualifications is not met, then all of the standard hours of service rules apply.

Electronic Logging Devices (395. Subpart B)

When requested by an authorized safety official, a motor carrier must produce ELD records in an electronic format either at the time of the request or, if the motor carrier has multiple offices or terminals, within the time permitted under 49 CFR 390.29. Requirements for ELDs can be found in 49 CFR 395 Subpart B. A motor carrier must retain for 6 months, a back-up copy of the ELD records on a device separate from that on which the original data are stored.

Motor carriers and drivers exempt from the ELD rule may use alternate recording methods, including automatic onboard recording devices (AOBRDs), to record their hours-of-service data. Requirements for AOBRDs can be found in 49 CFR 395.15.

More information about the ELD rule, including a complete list of exemptions, can be found on FMCSA's ELD website.

Submitting/Retaining Duty Status Paper Logs (395.8 (a)(2)(ii) and 395.8 (k))

A driver who is not subject to the ELD rule may still be subject to HOS regulation. In this case, the driver must submit the original paper log sheet to the employing carrier within 13 days after trip completion. The driver shall retain a copy of each ROD status for the previous seven consecutive days, which shall be in his/her possession and available for inspection while on duty. All hard copies of the driver's record of duty status must be signed by the driver.

When a motor carrier uses a driver initially or intermittently, the carrier must obtain from its driver a signed statement giving the total time on duty during the immediately preceding seven days, and the time at which the driver was last relieved of duty. See Hours of Service for First Time or Intermittent Drivers form. Records of duty status must be maintained, with all supporting documents, for a minimum of 6 months. See Sections 395.8 (a)(2)(ii) and 395.8 (k).

FMCSA also states:
The ELD applies to most motor carriers and drivers who are currently required to maintain records of duty status (RODS) per Part 395, 49 CFR 395.8(a). The rule applies to commercial buses as well as trucks, and to Canada- and Mexico-domiciled drivers.
The ELD rule allows limited exceptions to the ELD mandate, including:
   Drivers who operate under the short-haul exceptions may continue using timecards; they are not required to keep RODS and will not be required to use ELDs.
   Drivers who use paper RODS for not more than 8 days out of every 30-day period.
   Drivers who conduct drive-away-tow-away operations, in which the vehicle being driven is the commodity being delivered.
   Drivers of vehicles manufactured before 2000.

Thus, compliance becomes an issue and from these prior references it may be seen that these prior art patents are very limited in their teaching and utilization, and an improved device is needed to overcome these limitations.

### SUMMARY OF THE INVENTION

The present invention is directed to an improved an Electronic Logging Device Exempt Digital Fleet Management Solution using a driver interface as a mobile application communicating data into remote databases.

The invention embodies a digital solution that provides the tools and services necessary for short haul trucking fleets to comply with the short haul exception for fleets that are exempt from using Electronic Logging Devices (ELDs) to track their drivers' activities. The solution includes a mobile application (app) that drivers may use while on duty to capture and record their time, location, status, documents, and inspection report data, which is also sent to the cloud over the Internet. In the cloud, the data is stored in one or more databases. A website exists in the cloud which accesses and modifies said driver data collected from the mobile apps to provide fleet users with access and services related to said driver data. The driver may also message a website user or vice versa as well as scan and upload necessary documents to their fleet or third parties. The intended users of the invention are commercial trucking fleets or owner/operator fleets that are exempt from using Electronic Logging Devices (ELDs) to track driver activities as mandated by the Federal Motor Carrier Safety Association (FMCSA) under the ELD rule.

As previously noted, the driver, logging, and reporting rules change over time such that compliance is a constant issue for exempt drivers. The present invention has an objective to provide a system for individual drivers, fleet drivers, fleet managers, and other entities to manage these varying requirements. These and other objects and advantages of the present invention, along with features of novelty appurtenant thereto, will appear or become apparent by reviewing the following detailed description of the invention.

### BRIEF DESCRIPTION OF THE SEVERAL VIEWS OF THE DRAWINGS

In the following drawings, which form a part of the specification and which are to be construed in conjunction therewith, and in which like reference numerals have been employed throughout wherever possible to indicate like parts in the various views:

FIG. 1 shows the mobile app login page.

FIG. 2 shows the mobile app home page menu.

FIG. 3 shows the mobile app begin duty day page.

FIG. 4 shows the location service permission page.

FIG. 5 shows the duty timer page.

FIG. 6 shows the pre-trip inspection starting page.

FIG. 7 show the pre-trip inspection vehicle page.

FIG. 8 shows the pre-trip inspection vehicle page with a text note.

FIG. 9 shows the populated version of the pre-trip inspection vehicle page.

FIG. 10 shows the populated version of the pre-trip inspection trailer page.

FIG. 11 shows the timer page after the pre-trip driver vehicle inspection report (DVIR) is completed.

FIG. 12 shows the timer page after the driver clicks the “DRIVE” button or the auto-drive algorithm detects that the driver is moving.

FIG. 13 shows the popup after clicking the “END TRIP” button.

FIG. 14 shows the post-trip inspection starting page.

FIG. 15 shows a DVIR checklist.

FIG. 16 shows a maintenance dashboard overview.

FIG. 17 shows a maintenance report dashboard webpage for a tractor.

FIG. 18 shows a maintenance report dashboard webpage for a trailer.

FIG. 19 shows driver time report overview dashboard webpage.

FIG. 20 another driver time report detail webpage.

FIG. 21 shows the flowchart block legend for the process flows.

FIGS. 22A and 22B show the ELD exempt duty day app workflow process.

FIGS. 23A and 23B show the independent driver signup process.

FIGS. 24A and 24B show the independent driver app login process.

FIGS. 25A and 25B show the fleet app signup process.

FIGS. 26A and 26B show the fleet driver app login process.

FIGS. 27A and 27B show the pre trip DVIR process.

FIG. 28 shows the begin duty day process.

FIGS. 29A and 29B show the drive timer service process.

FIGS. 30A and 30B show the duty timer service process.

FIGS. 31A and 31B show the location service process.

FIGS. 32A and 32B show the post trip DVIR process.

FIG. 33 shows the end duty day app flow process.

FIG. 34 shows a schematic overview of the system.

### DETAILED DESCRIPTION OF THE INVENTION

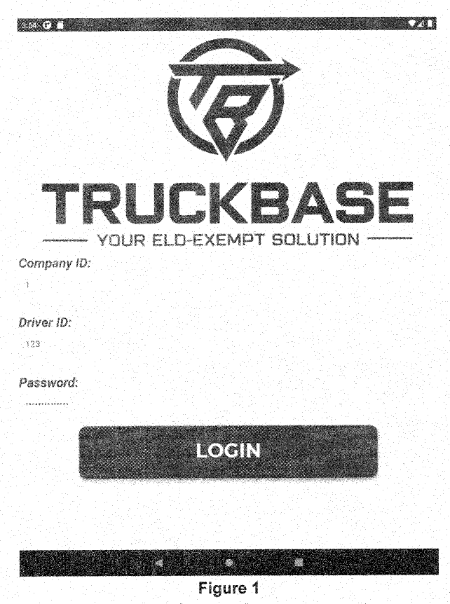

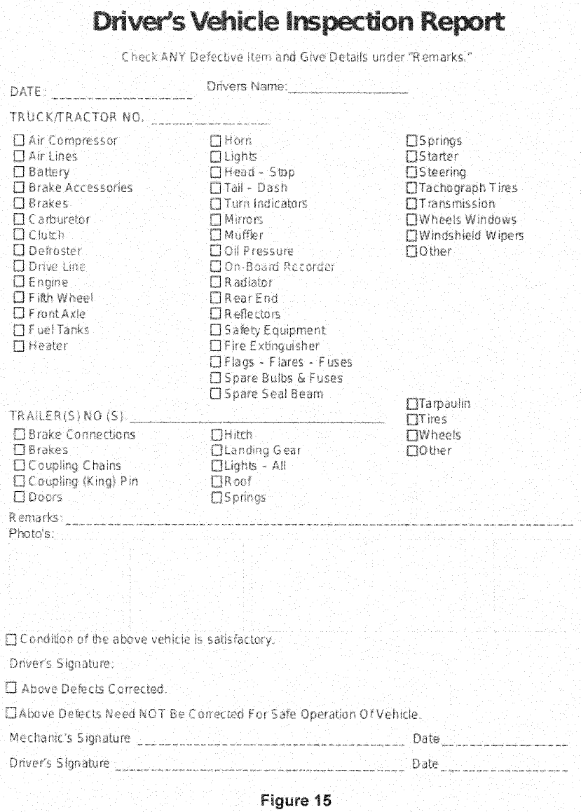

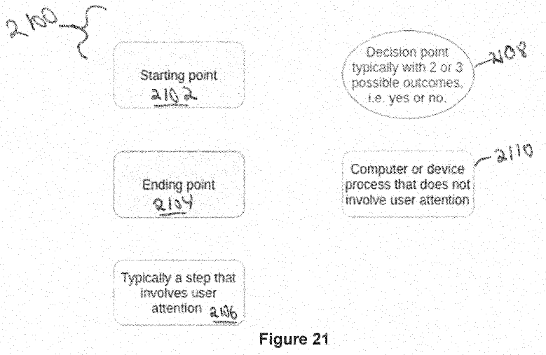

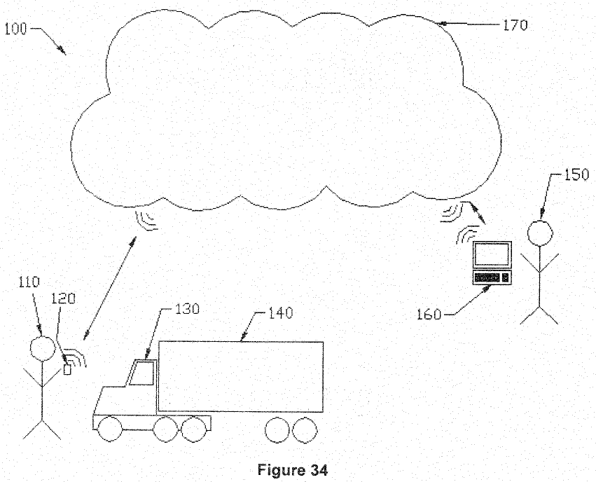

As shown in FIGS. 1-21, 22A, 22B, 23A, 23B, 24A, 24B, 25A, 25B, 26A, 26B, 27A, 247B, 28, 29A, 29B, 30A, 30B, 31A, 31B, 32A, 32B, 33 and 34 of the drawings, one exemplary embodiment of the present invention is generally shown as an electronic logging device exempt digital fleet management solution. FIG. 34 shows a schematic overview of the system 100. FIGS. 1-14 show the application pages presented to the mobile app users 110, FIGS. 15-20 show various website based reports available from the system and data, and FIGS. 21, 22A, 22B, 23A, 23B, 24A, 24B, 25A, 25B, 26A, 26B, 27A, 247B, 28, 29A, 29B, 30A, 30B, 31A, 31B, 32A, 32B, and 33 show the various process flows. Note that this is the current preferred embodiment, but changes will be necessary as regulations change for ELD exempt drivers such that this process will have to adapt to maintain compliance with the ELD Exempt requirements.

Within the following description, the following basic details provide the foundation for the system 100. The system 100 uses a mobile app 120 feeding data to a data processing computer 170 that can also be accessed by a web application 160. A mobile app 120 user 110 is typically a driver 100 that operates a tractor 130 that can be used by itself or the tractor 130 can also be used to pull a trailer 140. The words tractor 130 and vehicle 130 are used interchangeably, and they represent the commercial vehicle 130 that a driver 110 drives while using the mobile app 120 described within. The words mobile application 120, mobile app 120, and app 120 are used interchangeably. An example of a website 160 user 150 is a fleet manager 150. The words web application 160, web app 160, and website 160 are used interchangeably. The words data processing computer 170, backend 170, and cloud 170 are used interchangeably.

Despite the widespread availability of digital ELD solutions for fleets through the various providers, there is a tremendous lack of digital support for ELD rule-exempt trucking fleets. This makes it hard for ELD-exempt fleets to comply with the exemption criteria or to keep tabs on their equipment through a Driver Vehicle Inspection Report (DVIR) 1500. These fleets still need to keep the last 6 months worth of data on hand for their drivers 110, like the 6 months mandated under the ELD rule. The fleets that want to be ELD-exempt, without a digital solution, must use paper versions of forms filled out by hand by the drivers 110 to keep track of them. The drivers 110 then have to keep track of these forms and submit them to the necessary parties involved in the shipment process. This places additional burden on the fleets, notably the drivers 110, as the drivers 110 have to properly track time, remember to fill out the paperwork, and submit the paperwork to their company, who also has to deal with it in the back office for FMCSA compliance. Currently, this makes complying with the ELD rule much more convincing than not, both for efficiency and accuracy purposes, but it carries increased costs and regulations that only temporary solve the problem. Taking this approach makes the ELD-exempt trucking fleets again subject to the ELD rule and the pitfalls of using ELD providers such as increased costs and corporate inefficiencies that may cause fleet downtime, etc.

The embodied invention intends to provide a digital solution for compliance with the FMCSA exemptions to the ELD rule such as capturing duty day clock in, clock out, driver 110 status, driver 110 location, checking compliance with air mile radius requirements, providing alert when driver 110 is outside of air mile radius, completing vehicle 130 and trailer 140 inspection reports before and after trips, scanning, signing and uploading documents, messaging for load tickets, two-way communication with a website 160 user such as a safety or maintenance manager 150, etc. The invention includes a mobile application (app) 120 to be used by a driver 110 of a commercial vehicle 130 when they are working which sends data over the Internet to the cloud 170 where the data is stored in one or more databases and is available to fleet users through a website 160. The website 160 users may include, for example, fleet administrators that manage user accounts and oversee fleet performance, safety team members that make sure drivers 110 drive safely through a variety of means such as coaching, maintenance crew members that fix equipment issues as noted in inspection reports, and even the human resources department to access a driver's 110 data for employment history. The invention provides a means for fleets to digitally store and manage their driver 110 and equipment logs to remain compliant with the ELD rule exemption and have a single platform for managing their fleet.

Mobile/Telecommunications Background

For the mobile app 120, a mobile device exists which consists of a processor, a volatile memory, a non-volatile memory, one or more network adapters, a GPS chip, a battery, and a touchscreen that allows for user input including by means of an onscreen keyboard. The device may also consist of optional sensors such as one or more accelerometers, one or more cameras, one or more LIDAR scanners, etc. The network adapters are configured to transmit and receive data over a wireless network including cellular or WiFi. These networks are connected to the Internet and thus provide the mobile device with a connection to the Internet and to the cloud 170. Through these one or more internet connections, the mobile device can transmit data to or receive data from various servers in the cloud 170.

The app 120 includes a set of logic and instructions that is programmed into the nonvolatile memory of the mobile device. The app 120 can utilize the components of the mobile device such as the processor and volatile memory to operate. These mobile application 120 can have varying levels of priority and permissions. The app 120 can run in the foreground or background depending on priority and permissions. The user can choose to grant an app 120 certain permissions that it may request. The mobile device can execute one or more mobile applications 120 at a time.

Company and Driver Identification

In one embodiment of the disclosed invention, called embodiment A, each company or owner-operator that is a subscriber to services including the mobile app 120 and website 160 disclosed will have a unique company identification number (company ID) assigned to them. This number is a positive integer greater than or equal to 1 that uniquely identifies the company. The company is referenced by this number within every aspect of the system. The website 160 users then also have their own unique IDs that are a string of characters. In the same embodiment, the drivers 110 that use the mobile application also have their own unique IDs per their company. The driver 110 IDs are positive integers such as an employee ID, etc. In the website 160, users provide their company ID and user ID to login to the website 160 fleet management portal. Mobile application users, i.e. drivers 110, provide their company ID and driver 110 ID to login to the mobile app 120 service or to the web portal for drivers.

In another embodiment, called embodiment B, the drivers 110 are not necessarily assigned to a company, but they can use the app 120 for any job they do whether tied to a company or not. The driver 110's account in this case is tied to their email or phone number. Thus, they can still use the app 120 to collect similar data about themselves no matter if under a company and the data will exist throughout their career using the app. This data can be used in the future as a driving resume. Upon signing up to use the app 120 through the website 160 mentioned herein, they must sign an agreement with the company representing the solution embodied herein. The agreement, in minimal form, would deem it allowable for the company to collect the data of the driver 110 to an advanced security database or blockchain technology where it is stored for an indefinite duration for their driving resume purposes and big data analytics or machine learning usage such as for providing risk assessments, training or testing machine learning algorithms, geospatial analysis, statistical analysis, etc. In this embodiment, the drivers 110 can work for companies and be assigned company IDs as in embodiment A mentioned herein so as to be compatible with a cross-over application between both embodiments A and B of the solution. However, the drivers 110 in this embodiment B are not tied to a company permanently if they change jobs and their data continues to be collected to and live in the storage technology mentioned prior, i.e. a blockchain, no matter if they are working for a company or across multiple different companies.

Note that in any system or embodiment, Drivers can log in either through the app or website to access individual reports on their own data, export the information as needed, send the information to third parties, and utilize their cryptocurrency wallet to receive, buy, sell, exchange for goods or services, etc.

In embodiment A, where the driver 110 is attached to a particular company, the company will use the website 160 to create the driver 110 and then the driver 110 will be able to login the app 120 using a company id, driver 110 id, and generated password. In embodiment B, where the driver 110 is not tied to any one company, the driver 110 signs up for the app 120 using the website 160 or through the mobile app. No matter the embodiment, the driver 110 will be signed up with the solution by the following steps: 1) Scan of drivers 110 license to obtain department of motor vehicle records, 2) run publisher clearing house records, 3) run a DAC (trademark of HireRight, Inc., a Delaware Corporation, main offices at Suite 150 3349 Michelson Dr., Irvine Calif. 92612). Once this process is complete and the driver 110 is verified, they will be a valid user of the solution. The driver 110 records will be tied to the driver 110 using their driver 110's license once they are signed up for the app, and their data always stays associated with the driver 110 regardless of the company currently employing the driver 110.

Continuing from the prior mentioned embodiment B where the driver 110 is not tied to any one company, the solution can be used by the driver 110 if the company they work for supports usage of the app, or without a company (if they work for a company that does not support the app 120) but still would like to record their data to the secure database or blockchain to build a driving resume. The solution thus can be applied no matter when a driver 110 changes jobs, and it will collect and store their app 120 usage data history over time from throughout various jobs until they cease to use the app 120 altogether. The driver 110 will have the option to purge their driving history from the secure database or blockchain, but once it is purged, it cannot be recovered and the driver 110 will lose all of their valuable driving history. In order to purge their data, the driver 110 will have to sign an agreement and acknowledge the downsides of leaving the solution such as losing their digital driving history and being less marketable to potential employers in the trucking industry that rely on said data for hiring, etc. The company servicing the solution, upon this agreement with the driver 110, will then be able to delete the data or revoke all access to the data.

This collected data can be shared with potential employers that would like to see a particular driver 110's history, upon the driver 110's agreement with said employer, when considering the driver 110 for a job opportunity. This agreement and sharing can take place as a smart contract, i.e. in a decentralized application on the ethereum blockchain. The data can be used for the driver 110 to prove their routes driven throughout time, their inspections that were completed, or even if they had any events occur that can affect their hireability, etc. All of this driving proof would exist in a decentralized datastore if on the blockchain or a very secure database so that altering or deleting the data would not be possible by a third party. The data would not be openly shared with third party entities without approval of the driver 110 through a signed agreement.

Mobile Application

Data Collected from Device to Cloud

The invention includes a mobile application (“app”) 120 that may collect data about drivers 110 during their duty day and transmit the data to a database server over the Internet. The mobile app 120 is designed to reside on a mobile device situated in a vehicle 130 that will be driven by a driver 110 in which case both the vehicle 130 and driver 110 meet the ELD-exempt criteria. The driver 110 will be able to login to the app 120 if they or their company is a subscriber of the mobile app 120 service.

The mobile app 120 serves primarily to capture all duty day-related driver 110 input and data including, but not limited to, duty day clock in, duty time, driver 110 status, drive time, duty day break, and duty day clock out. The driver 110 is able and required to complete and file both pre-trip and post-trip DVIR 1500 from within the mobile app. The mobile app 120 may also capture GPS location of the mobile device and drive time while a driver 110 is on duty. The data is first captured to a database on the mobile device. The app 120 may capture data points at variable frequencies, such as N second intervals, where N is a positive integer such as 60 seconds. Different data points are captured at variable frequencies as necessary, for example driver 110 location is captured more frequently than other less crucial data points. The mobile app 120 then transmits the captured driver 110 data from the device to one or more database servers in the cloud 170 over an available internet connection. The mobile application may be used without an internet connection and shall sync with the database server over the internet when the next reliable connection is established to the Internet.

Data Retention

The logged data from the app 120 and many of the documents submitted through the app 120 may have to be retained for the fleets for 6 months in order to comply with FMCSA and other governing bodies. The fleets will have access to their portion of said data through the website 160 included within the invention.

Order of Operations in App

In FIGS. 1-14, the images of the mobile application depict the order of operations. The images are not intended to limit the scope, design, or features of the invention but provide an example of this embodiment of the invention. The order of operations when using the mobile app 120 is the following:

1) the driver 110 logs into the app 120 as shown in FIG. 1;

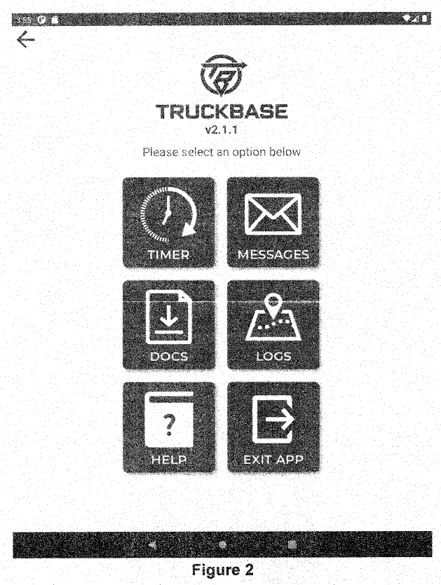

2) the driver 110 comes to the main menu of the app 120 as seen in FIG. 2;

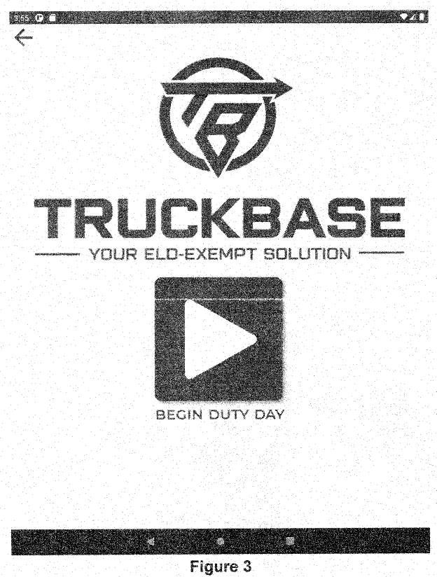

3) the driver 110 starts their duty day timer in the app 120 by clicking on the timer button as shown in FIG. 2 and clicking the begin duty day button in FIG. 3;

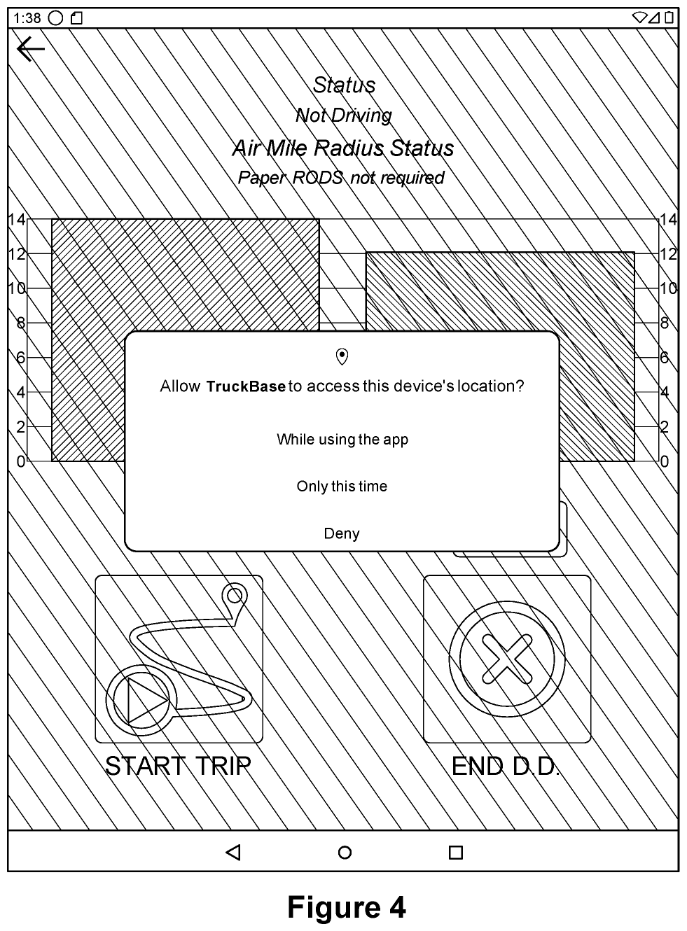

4) the driver 110 is prompted to allow location access or other give other permissions to the app 120 as shown for example in FIG. 4;

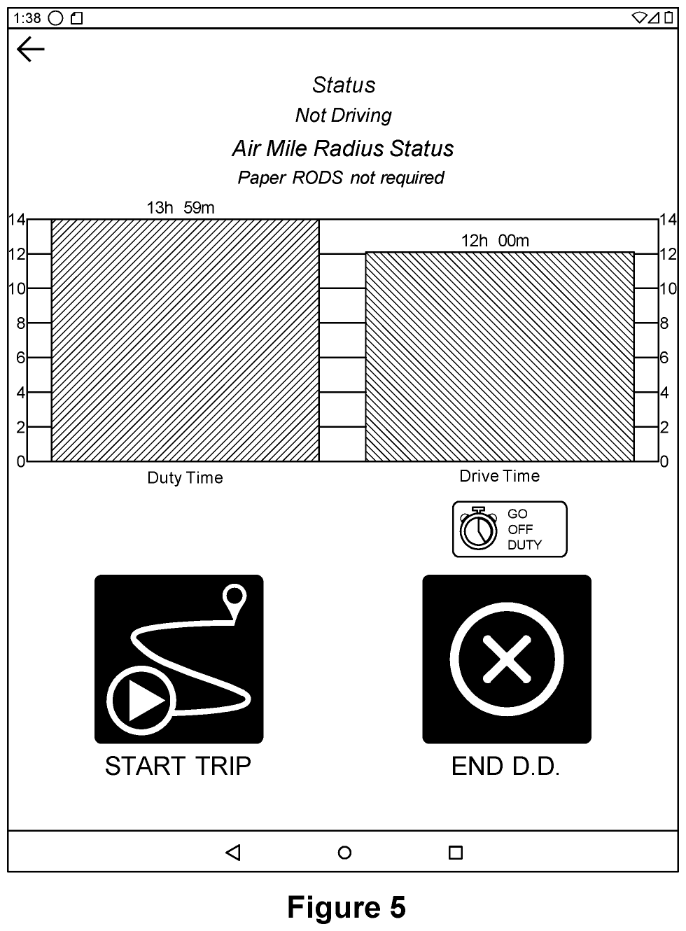

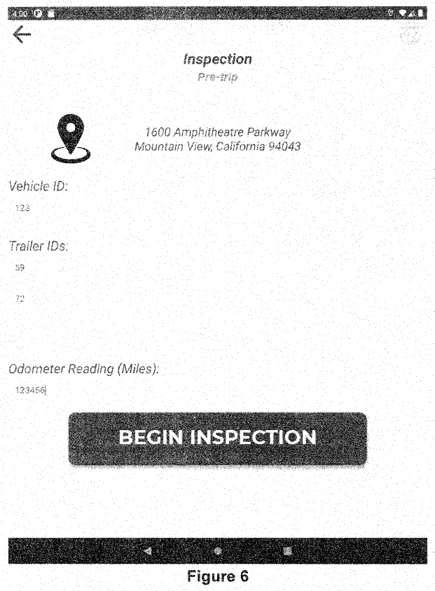

5) the driver 110 starts a trip by clicking the start trip button shown in FIG. 5 but is first prompted to inspect their equipment as shown in FIG. 6;

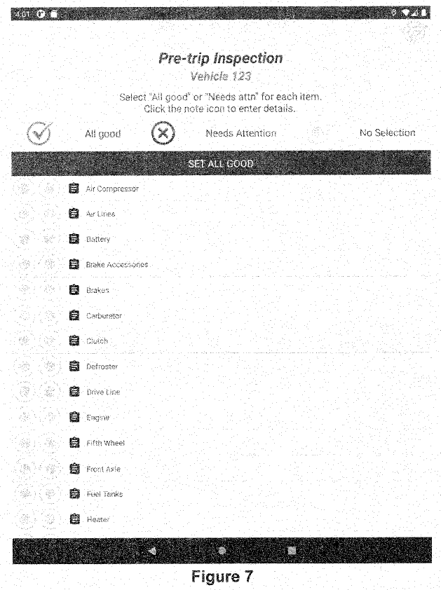

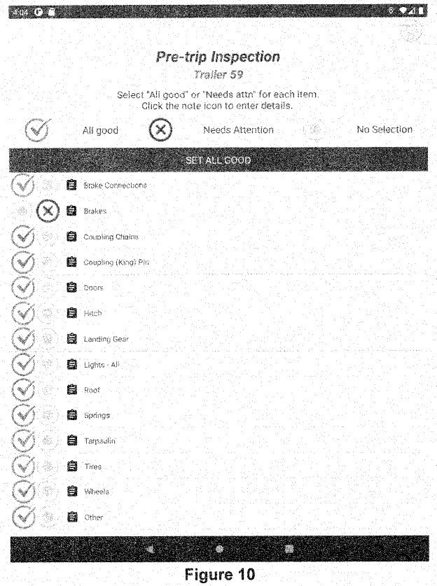

6) the driver 110 fills out the pre-trip DVIR 1500 where they enter tractor 130 and trailer 140 information such as tractor 130 ID, trailer 140 IDs, and odometer of tractor 130, then they inspect both the tractor 130, with inspection points and input options such as notes or images as shown for example in FIGS. 7, 8, and 9, and any trailer 140s, as in FIG. 10, attached to the tractor 130 that they will drive on the trip;

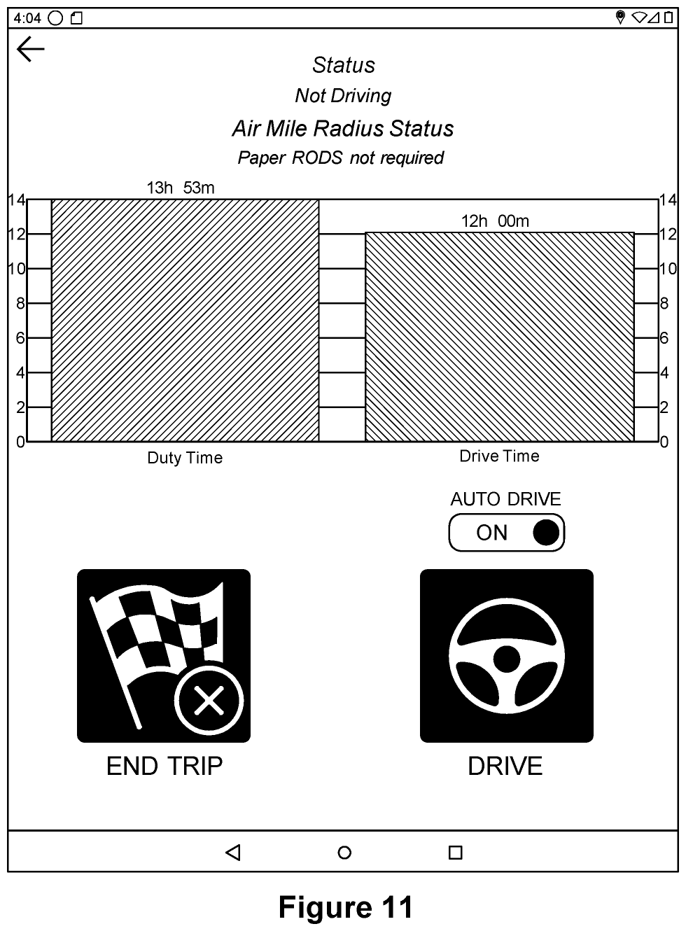

7) the driver 110 starts their trip and is redirected to the timer page shown in FIG. 11 which displays their ongoing duty time, drive time, and air mile radius paper RODS status which is frequently checked in the background via GPS, for example;

8) The driver 110 can click the back button in the top left corner in FIG. 11 to go to the main menu shown in FIG. 2 and select, for example, the “DOCS” button to fill out, scan using device camera, sign, or submit the forms necessary to begin their trip, i.e. bill of ladings, from a list of example forms mentioned later;

9) the driver 110 can click on the “TIMER” button to go back to the timer page which displays their duty timer which is running in the background and the app 120 is, at the very least, collecting timestamp, location, timer values, paper RODS status, and driver 110 status data;

10) the driver 110 can click the “DRIVE” button or use the auto-drive timer option shown in FIG. 11;

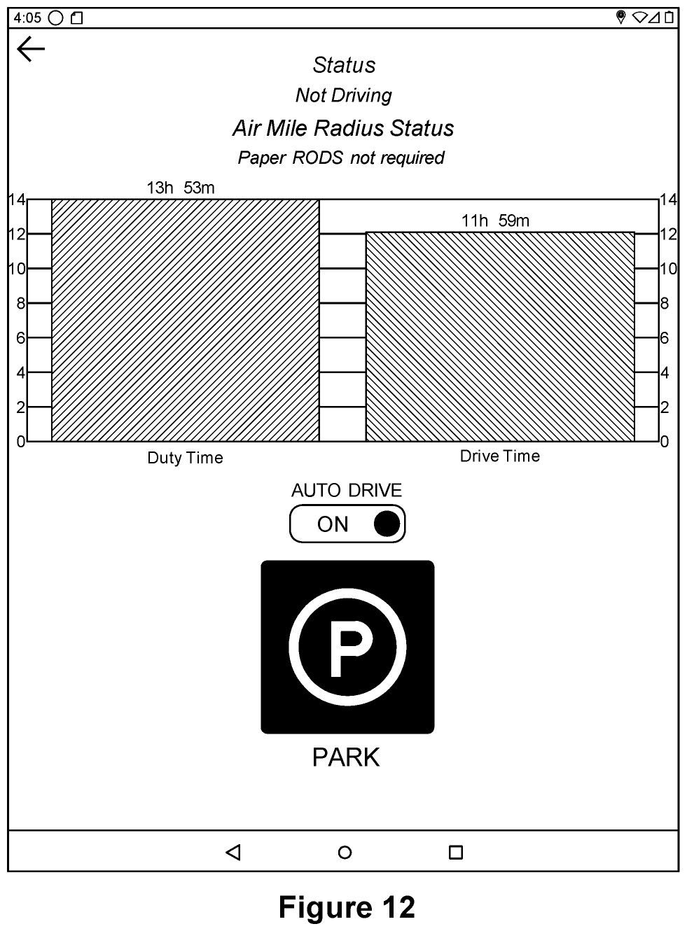

11) the app 120 screen changes to that shown in FIG. 12 as the drive timer runs and the driver 110 drives to their next stop where they click the “PARK” button;

12) once the driver 110 is parked, they are on the page in FIG. 11;

13) the driver 110 can alternate between drive and park several times while using the app 120 on a trip;

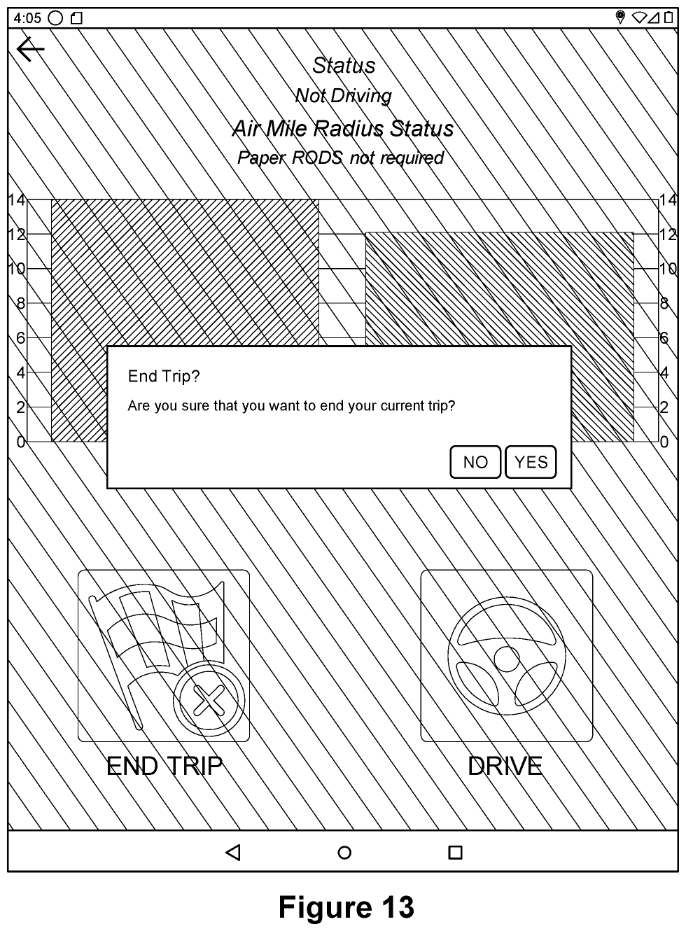

14) the driver 110 then completes their trip by clicking the end trip button shown in FIG. 11 and is asked if they are sure as in FIG. 13;

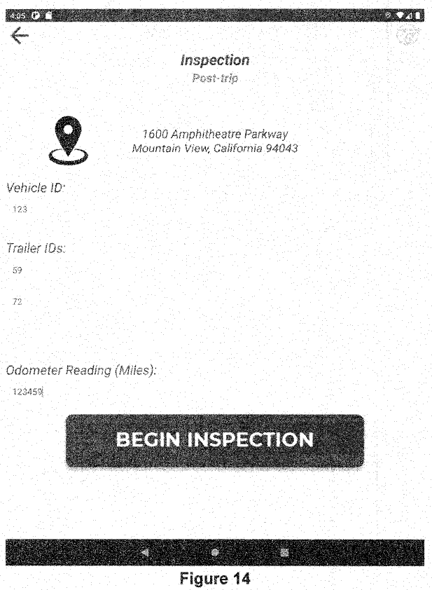

15) then the driver 110 must complete a post-trip DVIR 1500 with starting page shown in FIG. 14 where they fill in the tractor 130 ID, trailer 140 IDs, and odometer of the tractor 130 at the end of trip, and the rest of the inspection points and input options as a post-trip version of the pages shown in FIGS. 7 through 10, where they inspect the tractor 130 and any trailer 140s attached to the tractor 130 they drove;

16) the driver 110 submits this post-trip DVIR 1500 and then is redirected to a page as shown in FIG. 5 where their duty timer is counting down but their drive timer is paused;

17) driver 110 can start another trip by clicking the “START TRIP” button, pause their duty day timer to take a break by clicking the “GO OFF DUTY” button, or they can end their duty day clicking the “END D. D.” button which would prompt them if they are sure to stop the timer and stop it upon their agreement.

FIG. 1 shows a mobile app 120 login page with example credentials entered. The user clicks the “LOGIN” button to login to the app.

FIG. 2 shows a mobile app 120 home page menu. The user clicks the “TIMER” button to get to the timer page. The user clicks the “MESSAGES” button to open the messages page. The user can click the rest of the buttons to get to the section on the button label. Lastly, to exit the app, the user clicks the “EXIT APP” button.

FIG. 3 shows a mobile app 120 page for drivers 110 to begin their duty day. The user clicks the “BEGIN DUTY DAY” button to start their duty day. This triggers code to start collecting the time, location, and driver 110 status logs to a database on the mobile device and it transmits them to a cloud 170 database server over the internet connection when connected.

FIG. 4 shows an app 120 prompts the driver 110 for permission to run the location service in order to collect the location of the driver 110.

FIG. 5 shows a duty timer page prior to a driver 110 starting a trip. The duty timer runs once the driver 110 begins their duty day but the drive timer does not run until the driver 110 starts a trip and either manually starts the drive timer or the auto-drive algorithm detects that the driver 110 is driving.

FIG. 6 shows a pre-trip inspection starting page. Upon clicking the “START TRIP” button on the timer page, the app 120 navigates to this pre-trip inspection page where the driver 110 can begin the inspection process by entering their vehicle 130 ID, trailer 140 IDs, and odometer reading of the vehicle 130 at the time of inspection. The driver 110 can then begin the inspection by clicking the “BEGIN INSPECTION” button.

FIG. 7 shows a pre-trip inspection vehicle 130 page. Upon clicking the “BEGIN INSPECTION” button from the pre-trip inspection starting page, the app 120 navigates to this page where the driver 110 can input inspection information related to the listed vehicle 130 components. This information includes a positive status of “All good” or a negative status of “Needs Attention” as well as text notes and images of the components that need attention. A driver 110 can add text notes for an item by clicking the clipboard icon next to the item and filling in the text in a pop-up that appears. The optional “SET ALL GOOD” button can be used by the driver 110 to automatically fill all of the inspection items with a positive status to eliminate manual clicks if all items are good.

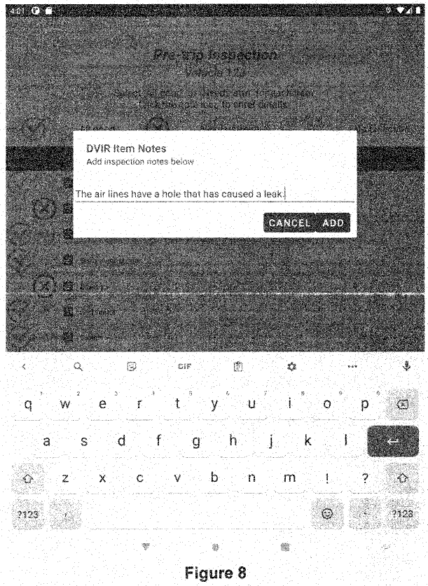

FIG. 8 shows a pre-trip inspection vehicle 130 page while adding a text note to an item. The driver 110 enters the notes using the onscreen keyboard and then clicks “ADD” to add the note to the item in the report.

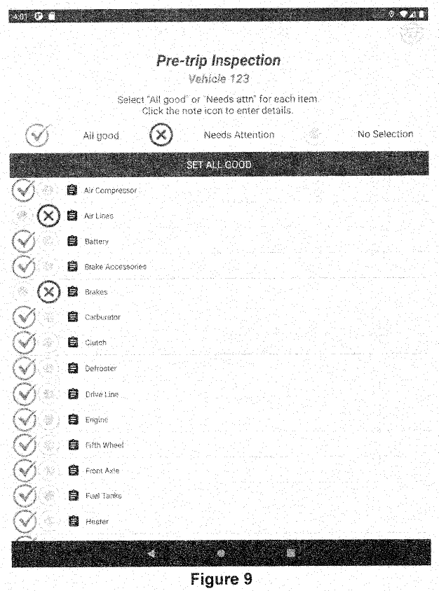

FIG. 9 shows a populated version of the pre-trip inspection vehicle 130 page. In this case, the air lines and brakes need attention from the fleet's maintenance team. At the end of the vehicle 130 inspection page found by scrolling down, there is a “NEXT” button. The driver 110 clicks this button to move to the trailer 140 inspection page or if they do not have a trailer 140, then it will turn into a “SUBMIT” button that they can click to submit the pre-trip inspection report.

FIG. 10 shows a populated version of the pre-trip inspection trailer 140 page for one of the trailer 140s. This page has all the features of the vehicle 130 inspection page such as notes and images. At the bottom of this page, there is a “NEXT” button that the driver 110 can click to either inspect the next trailer 140 or it will turn into a “SUBMIT” button to submit the report. Upon submitting the report successfully, the app 120 navigates back to the timer page.

FIG. 11 shows a timer page after the pre-trip DVIR 1500 is completed.

FIG. 12 shows a timer page after the driver 110 clicks the “DRIVE” button or the auto-drive algorithm detects that the driver 110 is moving. After the driver 110 clicks the “PARK” button or the auto-drive algorithm detects that the driver 110 has stopped moving, the app 120 navigates back to the prior page with “Not Driving” status where the drive timer is stopped.

FIG. 13 shows a page with popup after click the “END TRIP” button.

FIG. 14 shows a post-trip inspection starting page. It has all the same features as the pre-trip inspection page.

Driver 110 Statuses in App

The driver 110 status data collected may be, but is not limited to, one of the following statuses: start duty day, pre-trip DVIR 1500, on duty and driving, on duty and not driving, off duty, post-trip DVIR 1500, end duty day. The statuses assigned to the driver 110 and their data are determined by their status in the app 120 at the time when the data is being collected. For example, when a driver 110 is filling out the pre-trip DVIR 1500, then their status in the data collected is “pre-trip DVIR 1500”. If they were on duty and driving, where both their duty and drive timers are running, the status is “on duty and driving” or if not driving then “on duty and not driving”, for examples. The driver 110 statuses help website 160 users determine what the drivers 110 were doing at particular points in time when the data was collected in order to drive decision-making, etc.

App 120 Profiles and Rules:

The app 120 will have different driver 110 profiles depending on the types of drivers 110 using the app. Each profile has various parameters associated with it including how long that type of driver 110 can be on duty or drive over a certain period of time, i.e. 7 days. For example, there are various profiles created, such as: 1) a city profile where the drivers 110 can drive up to 70 hours over a 7 day period or 2) a road profile where the drivers 110 can drive 80 hours over an 8 day period. When the drivers 110 extend beyond that profile's parameters as set by the fleet, they will be alerted and must agree and acknowledge that they will work over said limit. The drivers 110 will be assigned to a profile from the backend 170 website 160 via the fleet users that have the required permissions.

The time clock rule will have a rolling clock that accumulates a driver 110's time over a specific time period as associated with their driver 110 profile. The driver 110 time is derived from their time on duty or time on duty while driving based on the profile parameters. The only thing that resets this rolling clock for any driver 110 is a period of 34 consecutive hours off duty for that driver 110. Therefore, a driver 110 of any profile type may be subject to a rolling clock rule where if they go beyond their duty or drive time parameters, they will be alerted in the mobile app 120 and they must agree and acknowledge to continue with their duty day knowing that they are going over their designated time limits as assigned by the fleet. They will then likely have to maintain paper RODS outside of the app 120 to keep track of their time in order to comply with FMCSA rules.

Paper records of duty service (RODS) are required if the driver 110 works over 14 hours on a duty day which includes a combination of driving and duty time or travels over a 150 air mile radius. If this rule is violated over 8 times in a period of 30 days, for example, then the driver 110 must use ELD and is no longer considered ELD exempt.

DVIR 1500

FIG. 15 shows an example DVIR 1500 checklist that a driver 110 fills out during an inspection. The embodied invention provides a digitized version of this inspection brought to a modern day mobile app. Driver vehicle inspection reports (DVIR 1500) are inspection reports filled out by drivers 110 before or after they drive a vehicle 130 or haul a trailer 140. A DVIR 1500 may consist of one or more inspection points on a vehicle 130 or trailer 140 or both in combination. DVIR 1500s are used for compliance with regulations and industry standards in areas such as safety and maintenance. The DVIR 1500s will be filled out and submitted through the mobile app 120 by drivers 110. The DVIR 1500 vehicle 130-specific items may include, but are not limited nor must adhere to, the items in the tractor 130 section of FIG. 15. The trailer 140-specific items may include, but are not limited nor must adhere to, the items in the trailer 140 section of FIG. 15. The DVIR 1500 may include images or notes about items with issues that need attention. The driver 110's and mechanic's signatures and dates thereof are also typically collected on the items to acknowledge that both parties have collected and reviewed the results.

Mobile DVIR 1500

When the driver 110 starts the pre-trip or post-trip inspection process in the mobile app, the driver 110 is prompted for the vehicle 130 ID representing the vehicle 130 they are driving or drove, zero or more trailer 140 IDs for trailer 140s that are attached to that vehicle 130, and the odometer value of the vehicle 130 at the time of inspection, as shown in FIG. 6. In addition to this information, the DVIR 1500 may consist of a vehicle 130 inspection report and zero or more trailer 140 inspection reports, depending if any trailer 140s are attached to the vehicle 130, that together compose the overall pre-trip or post-trip DVIR 1500. Once the driver 110 enters the vehicle 130 ID, trailer 140 IDs, and vehicle 130 odometer, they proceed to complete the vehicle 130 portion of the DVIR 1500 as shown in FIG. 7. Once the driver 110 is finished with the vehicle 130 portion of the DVIR 1500, they complete the trailer 140 portions of the DVIR 1500 as shown in FIG. 10, if there are any. Once these are completed, they can submit their entire pre-trip or post-trip DVIR 1500 to the website 160 for users from their company to review, make decisions from, etc. A driver 110 must submit both a pre-trip and post-trip DVIR 1500 to comply with the mobile app 120 guidelines.

A driver 110 may submit one pre-trip or one post-trip vehicle only DVIR 1500 per trip if they are not hauling a trailer 140; otherwise, the driver 110 must submit one pre-trip and one post-trip vehicle DVIR 1500 per trip as well as one pre-trip and post-trip trailer DVIR 1500 per trailer 140 that they are hauling at the time of inspection. Each DVIR 1500 list consists of predetermined items, whether determined by the mobile app 120 service or website 160 user configurations from fleet users. Each list consists of one or more items per type of equipment under inspection. The driver 110 must go through and physically inspect each of the listed items in the DVIR 1500 and then provide their inspection results through the mobile app. While inspecting each item for issues by examining the physical items on the vehicle 130 or trailer 140s, the drivers 110 must choose whether the item is good or if it needs review through a radio button or a checkbox input. The radio button legend is shown where the “All good” status is a blue check mark and the “Needs Attention” status is an x mark as in FIGS. 9 and 10. Per each item, the driver 110 may take notes, as shown in FIG. 8, that describe the issues on the items that need clarification in the mobile app 120 by clicking the notepad icons shown in FIG. 7, for example, on the row of the issue item, and they can attach helpful images to the item which are taken by the mobile device camera in the mobile app 120 to depict the one or more issues pertaining to those items. The attached pictures will be taken through the mobile device camera and will be saved to a database on the mobile device similar to the rest of the mobile app 120 data.

Once the driver 110 has finished their pre-trip or post-trip DVIR 1500, they submit the report in the mobile app. Then, the report data, including item statuses, notes, and images, are sent over an available Internet connection to a remote cloud 170 database. This mobile app 120 DVIR 1500 data may be retained for a period of 90 days, for example, as required by the fleet for bookkeeping or regulatory purposes. Once a DVIR 1500 is received in the remote database, a process is used to check the data for items that need review and then send the website 160 a trigger to notify designated website 160 users from maintenance or safety teams when items are warranted for review based on, for example, a criteria set by fleet manager 150s in the website 160. Items are automatically or manually assigned priority labels. The priority label may be a number, word, phrase, or color-coding of the notification text. The maintenance and safety teams at the fleet can then review the issue DVIR 1500s and make decisions on whether the driver 110 can use the vehicle 130, if it needs to be routed in for maintenance, etc.

These website 160 users are able to message or block a driver 110 from continuing with their trip with a certain vehicle 130 or trailer 140 based on the importance of the issues tracked in the DVIR 1500. The block is a message sent over the Internet from the website 160 user, through means of the website 160, to the driver 110's mobile app 120 related to the issue DVIR 1500. The equipment use block is automatically or manually sent by the website 160, depending on the criteria specified by the fleet. The mobile app 120 then alerts or blocks the driver 110 from continuing with the equipment, present a pop-up about how they should handle the situation, and may force them to cancel or end a trip with the issue equipment. The driver 110 can then be blocked from using the vehicle 130 or trailer 140 with an issue until the issue was resolved in the system.

Messaging

A driver 110 using the mobile app 120 may message one or more users on the website 160 application. The messaging section of the mobile app 120 is accessible by clicking the “MESSAGES” button shown in FIG. 2, for example. A website 160 user may also message one or more drivers 110 on the mobile app. The messages sent in either direction may include, but are not limited to, text or images.

Documents Including Load Tickets

Load tickets can be created using a third party dispatching service through APIs. The load ticket can be assigned to a driver 110 using the mobile app 120 which then assigns the driver 110 to that load upon their acceptance. The driver 110 is alerted for the assigned load ticket and can choose to accept or reject the ticket. Whether they accept or reject the ticket, it sends a message to the third party service that will assign the driver 110 to the load if accepted or will not if rejected. If the driver 110 accepts, the load information is then sent to the driver 110 through the mobile app.

The driver 110, through the mobile app 120 via the “DOCS” button in FIG. 2, and fleet users, through the website 160, can proactively track their loads. The loads have many associated documents, including but not limited to the following:

Bill of lading—has bill lading number, like a tracking number, and trip number which is tied to trip document—created by the shipper and provided to the driver 110. It may include the company shipping the load, the bill of lading number, i.e. XYZ-5422, what is in the shipment, i.e. 10 pallets of this, 5 pallets of that, etc. will send figure if necessary. The bill of lading can be provided digitally through an API to the embodied solution or it can be scanned if in paper form and presented if neccessary as a set of checks and balances from either the mobile app 120 or website 160 of the embodied invention. The bill of lading provides location to the parties involved in the shipment, i.e. the party that ordered the shipment. The location will be updated by the mobile app 120 using the data collected from the mobile app 120 on the driver 110's location.

Scale tickets—weight scale—driver 110 would scan the scale tickets into the app 120 and it can be sent to the back office. The scale ticket can be sent from the scale machine directly to the mobile app 120 through Bluetooth or from the scale machine directly to the solution backend 170 through an API endpoint over the Internet.

Roadside inspection report—useful for when pulled over by police—not DVIR 1500—produced by a police officer. Officer completes a paper form and the driver 110 will take a picture of the form and upload it through the mobile app 120 to the backend 170 database. The roadside inspection report will be tied to the driver 110 and if it reveals any violations then it is tied to the driver 110's CDL no matter who they are driving for. The inspection information will be tied to the driver 110 CDL through a third party API. The website 160 will be able to display these roadside reports to the fleet website 160 users upon request.

Trip document—trip number—provided by the fleet. The trip documents are tied to the bill of lading forms. These documents include trip details.

Delay document—reasons why delayed—produced by driver 110—can get paid for delays if over a base time such as an hour of delays.

Accident Report

The driver 110 may complete or scan and submit an accident report through the app. They may take pictures through the app 120 via the mobile device camera, and those pictures will be associated and submitted with the accident report. This feature is accessible through the “DOCS” button on the main menu of the app 120 shown in FIG. 2. The accident report can be sent to the parties necessary. It can also be tied with their data in the backend 170 for driver 110 analytics and risk assessment purposes, for example.

Training/Coaching

The mobile app 120 may include training or coaching materials provided by the mobile app 120 service or the company employing the driver 110. The training section is accessible through a button in the mobile app 120 found on the main menu, which is present as the other buttons shown in FIG. 2. The training materials may include documents, videos, or lessons with guidance on how to improve safety, time management, or regulation adherence, to name a few areas. These training materials may be based on, but not limited to, company guidelines, industry guidelines, or industry regulations such as ELD exempt criteria provided by FMCSA. The coaching materials may be based on, but not limited to, data collected from the mobile apps of one or more drivers 110 from one or more companies, driver 110 performance reviews, management feedback, etc. The lessons may include videos that are 5 to 10 minutes long, for example, and after the video, there is a test administered to evaluate a driver 110's learning about the information. Required training or lessons may be pushed down to the app 120 for particular drivers 110 from the website 160 via fleet users with the necessary permissions to assign training or lessons to the drivers 110.

An example lesson can be about how to plan trips and stay within the 150 air radius to keep within the short haul exemption and remain ELD exempt. This example lesson would target drivers 110 who kept extending beyond the 150 air mile radius from their starting location over a certain period of time, i.e. 30 days. This can help fleets keep their drivers 110 in check without completely micromanaging them. When lessons apply to a driver 110, for example, if they frequently travel beyond a 150 air mile radius in a certain period of time, then the app 120 may provide an alert or push notification to the driver 110 suggesting they complete the example lesson mentioned earlier in order to help fix their bad habits.

Various other lessons can be provided such as how to control emotions, distance keeping, lane keeping, refrain from speeding, driving maneuvers, inspection standards when completing DVIR 1500 such as ways to inspect equipment of certain types, what to look for or take pictures of, when to take notes and what to include, etc. When a driver 110 completes training, they may receive points or cryptocurrency tokens as a reward. The reward system is discussed later.

Other Sections of the App

The mobile app 120 may have other features and functionalities then previously mentioned such as providing the driver 110 the ability to view their time and location logs in the app, the ability to review prior DVIR 1500 or other documents submitted in the app, a help section for drivers 110 to get familiar with the app 120 and learn how to use it, etc.

Texting During Driving Detection

The mobile app 120 may determine and collect information related to if a driver 110 using the mobile app 120 was accessing, creating or sending text messages while the tractor 130 was moving by using an example combination of their status, i.e. on duty and driving, the GPS location of the vehicle 130, and the speed of the vehicle 130 along with the status of their text messaging app 120 or if they were touching the screen and then comparing the data points on a timeline to see if they touched their screen while they were driving. If they were, the driver 110 is alerted in the app 120 about their actions. The website 160 users may also receive alerts or reports that showcase how much screen activity a particular driver 110 had during a certain time period, etc.

Blockchain

The data collected from the mobile app 120 is written to a blockchain. The blockchain will represent the data collected by the app 120 and will be referred to throughout as the blockchain. The blockchain will be immutable and thus cannot be changed. The data contained on the blockchain will reveal the truth of all drivers 110′ driving history who use the mobile app 120 in embodiment B of the invention, for example. This history can serve as a driving resume for fleets to review when planning to hire a driver 110. The data will prove if a driver 110 is a good or bad driver 110. The data will be retrievable from the blockchain for a fee. The fee will be paid initially in US dollars and eventually in a cryptocurrency.

Reward System

The driver 110, upon signing an agreement with the company, is entered into a program with the company where they may be rewarded for accomplishing various tasks through the mobile app. Some of these tasks can be to drive around and use the app 120 to collect data for N miles or for H hours where N and H are positive integers. Tasks can also include doing pre-trip and post-trip DVIR 1500 and finding issues on equipment for the equipment they are assigned to. The reward system can be based on points that are valid with the company and its partners, such as truck stops, that use the point system, or the rewards can be disbursed using a new or existing cryptocurrency. The cryptocurrency option would bring the drivers 110 using the app 120 a decentralized, digital, and secure way to transfer and hold value from their driving data. The mobile app 120 may have a points wallet or cryptocurrency wallet tied to it, either provided by the mobile app 120 or by another third party wallet provider. The link between the mobile app 120 and a third party digital wallet is agreed upon and orchestrated by the driver 110 using the app. The driver 110 accesses this portion of the app 120 through an optional “wallet” or “rewards” button on the main menu of the app 120 shown in FIG. 2.

The reward system can also apply machine learning to enhance the gamification of using the mobile app. The machine learning algorithms would use the data from one or more drivers 110 to determine which drivers 110 should be rewarded vs a pool of users. The users are asked to complete one or more tasks and meet one or more requirements associated with said tasks in order to earn a reward in points or cryptocurrency as mentioned previously.

Website

A computer run and network program such as a web application, better known as a website 160, is created for consumers of the data collected from the mobile app 120. The website 160 is used for fleet management purposes, including allowing subscribed users to see reports based on collected driver 110 data and to manage the driver 110 accounts associated with the mobile app. The website 160 provides access to and consist of various forms of collected data, including, but not limited to, data in raw form such as a data tables of collected mobile app 120 driver 110 data, data in aggregated or summarized form such as a driver 110 time summary report, data in geospatial form such as driver 110 locations plotted on a map, data in filtered form such as data from a specific time range, data collected for inspection purposes including imagery or driver 110 notes, or even a combination of these forms of data. Reports are offered and delivered in a variety of formats including PDF, MS word document, XML, JSON, etc. Reports and data are available to consumers through application programming interfaces (APIs) which allow them to access the data in an automated fashion using a computer 170 program over an Internet connection, etc.

Permissions

Website 160 users exist in the website 160. Each website 160 user is associated with a company ID. The website 160 users from each company are granted certain permissions based on their roles. User permissions may include, but are not limited to, reading data, altering data, creating or modifying app 120 users, requesting reports of certain categories, ability to download content, etc. If a user has the permissions to create or modify a mobile app 120 user, for example, then they can add or remove drivers 110 that use the app 120 on behalf of their company.

User accounts may also exist on the website 160 for API access such as for third party applications to pull data. This will allow the proposed solution to further integrate with other applications such as for vehicle 130 or trailer 140 parts ordering.

User Management

The website 160 users with applicable permissions are able to create, suspend, or terminate mobile app 120 user accounts. The users granted the access are those that deem whether a driver 110 is employed by the fleet. The mobile app 120 user accounts may have various settings or parameters associated with them that can be changed by website 160 users with the proper permissions. These settings might include, but are not limited to, the following: how long of a duration a driver 110 can drive; how far of a distance the driver 110 can drive, i.e. in terms of miles; how many days of the week or which days a driver 110 can drive; the inspection items associated with the pre-trip or post-trip DVIR 1500 for one or more particular drivers 110; the allowed geofenced area associated with one or more particular drivers 110, etc. The website 160 user has the ability to set a default for several users or even potentially across the entire fleet.

If a driver 110 in the mobile app 120 tries to override any of the fleet settings, they would receive an alert in their device that they would have to acknowledge while the app 120 kept logging data in the background so as to not lose any valuable data. The driver 110 can choose to override the settings if the fleet user gave permission on the backend 170 website 160.

Altering DVIR 1500 Items for Mobile App 120 Users

Designated website 160 users can change the DVIR 1500 list items that are shown and required in the mobile app. The website 160 user is able to push the DVIR 1500 changes (inspection items listed) to the mobile app 120 for their drivers 110. After a DVIR 1500 change is pushed to the drivers 110 by their company, their app 120 will update with the new DVIR 1500 once it connects to the Internet. After this update occurs in the app, the next time the driver 110 has to complete a DVIR 1500, they would see the changes from the website 160 user and fill out the new version of the DVIR 1500 to submit.

Reports in Website 160

The website 160 may offer many types of dashboards and reports to users based on the collected driver 110 data and inspection reports from the mobile app 120 as well as including the feedback from the maintenance and safety teams where applicable. The dashboards and reports may include those which cover the following topics: driver 110 hours of service including the breakdown of how long they were driving and how long they were parked, how long they had been on duty and driving for the duty day, etc.

A List of Example Reports

1. Driver 110 time, i.e. daily breakdown of time driving (on duty and driving), time parked (on duty, not driving), or length of breaks between trips over one or more duty days (not on duty and not driving).

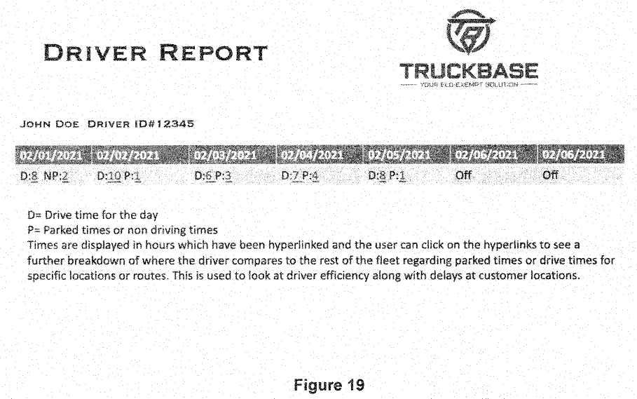

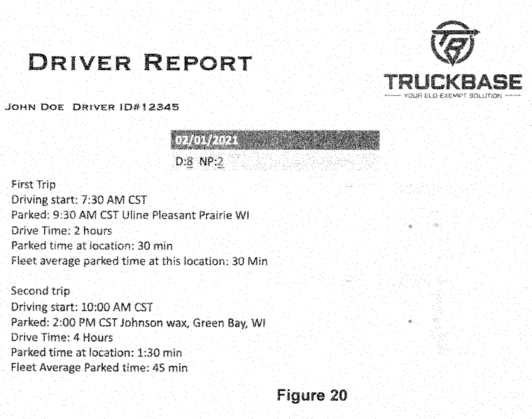

a. Example dashboard report webpages are shown in FIGS. 19 and 20

b. In FIG. 19, the times or duty status, i.e. off duty, for one or more particular drivers 110 are listed for N days where N may be a positive integer, i.e. 7 days. The drivers 110 shown in the report as well as the number of days shown are selectable by the website 160 user. The driver 110 name and ID are listed on the report page. The table showcases the amount of time that the drivers 110 drove and were parked during the time period, or it will show if they were off duty, for example. This is used to look at driver 110 efficiency along with delays at customer locations.

c. In FIG. 20, the details are shown for a particular driver 110's duty day such as the driver 110 name, driver 110 ID, drive time and parked time for the day, and trip details such as driving start times, park times, the locations they were located when driving or parked, which are shown on a map, and the average park time for the fleet at the same park locations for comparison, etc. Additional items can be the Driver 110 location, i.e. maps with pop ups and legends, and DVIR 1500 maintenance breakdown information and times.

FIG. 19 shows an n example driver 110 time report overview dashboard webpage. This page is shown on the website 160. The times or duty status, i.e. off duty, for one or more particular drivers 110 are listed for N days where N is a positive integer, i.e. 7 days. The drivers 110 shown in the report as well as the number of days shown are selectable by the website 160 user. The table showcases the amount of time that the drivers 110 drove and were parked during the time period, or it will show if they were off duty, for example. D=Drive time for the day. P=Parked times or non-driving times. The times are displayed in hours which have been hyperlinked. The user can click on the hyperlinks to see a further breakdown of where the driver 110 compares to the rest of the fleet regarding parked times or drive times for specific locations or routes. This is used to look at driver 110 efficiency along with delays at customer locations.

FIG. 20 shows an example driver 110 time report detail webpage that is available to users on the website 160. This page is accessed by clicking through the hyperlinks on a prior driver 110 time overview dashboard. The detail page consist of the driver 110 name, ID, drive time and parked time for the day, and trip details such as driving start times, park times, the locations they were located when driving or parked, which is shown on a map, and the average park time for the fleet at the same park locations for comparison, etc.

Additional reports may consist of the following:

1. Driver 110 Detail

a. Driver 110 ID

b. First, middle, last name

c. Fleet/carrier

d. Home Terminal

e. Driver 110 Type—ELD EXEMPT

2. Hours of service

a. Violations—over 12 hrs driving, 14 hrs duty day, or over 150 air mile radius

i. Report Name

ii. Report Description

iii. Time Period

iv. Terminal Name

v. Time Zone?

3. Availability Report Table—can select from one driver 110 or list all drivers 110

a. Driver 110 Name

b. Last Status (Off, Driving, On Duty, Not Driving)

c. Paper logs status

d. Status Start Timestamp

e. Status Location

f. Driving TIme Left (out of 12 hr)

g. Duty Time Left (out of 14 hr)

h. Work Shift Driving—12 hrs

i. Work Shift Duty—14 hrs

j. Duty Time Cycle—tracks hrs left in 7 day period (out of 70 hr in 7 day period)

i. This is a rolling clock of their time over the last 7 day period unless driver 110 takes 34 hrs off, then clock resets

4. Driver 110 Log Multi-day View—select last N days view, where N is a positive integer, i.e. 7 days

a. Gantt chart

b. Data table

5. Electronic DVIR 1500 (eDVIR 1500)

a. Show what the driver 110 submitted from app 120 DVIR 1500

b. Vehicle 130 ID

c. Trailer 140

d. Trailer 140 Hub

e. Hazmat placards

6. Maintenance

a. Same driver 110, same truck—box on DVIR 1500 checked once and sends once to maintenance—doesn't send every time

b. Once repair is done, check goes away

c. When issue reported on DVIR 1500, start timer for each issue—see how long it takes someone to look at it

7. Driver 110 Analytics

a. Max Air Mile Radius from Home Terminal

b. Drivers 110 driving too far/too much

c. Drivers 110 not going far enough/driving enough

i. Determining the issues that are causing drive time disruptions

d. Number of DVIR 1500s submitted by driver 110

i. May compare driver 110 to fleet or many fleets

e. Average DVIR 1500 completion time

i. May compare driver 110 to fleet or many fleets

f. Average parked time, where driver 110 is on duty and not driving status, for example

g. Average length of break time on a duty day where driver 110 is off duty and not driving

8. Texting during driving activity

a. For example, showcasing the amount of screen activity a driver 110's device had while they were driving, i.e. on duty and driving status, over a certain period of time

9. Risk Assessment or profile as described later in document

a. Can be based on various data points collected using the mobile app 120 including GPS, accelerometer of phone for braking, etc.

Maintenance

Driver 110 Vehicle 130 Inspection Report (DVIR 1500)

The DVIR 1500s completed by the drivers 110 in the mobile app 120 are sent to the website 160 for the maintenance or safety teams from the company to review. This mobile app 120 DVIR 1500 data may be retained for a period of 90 days, for example, as required by the fleet for bookkeeping or regulatory purposes. The maintenance or safety teams may deem a tractor 130 unusable, unsafe, or too risky to drive without service based upon the item or items that were selected to be unsafe or unusable. Seeing companies may haul more than one trailer 140 at a time based on state regulations, they may also deem one or more trailer 140s unusable, unsafe, or too risky to haul without service. The website 160 server has algorithms that run to generate an alert for the maintenance or safety teams based on criteria determined by the company or the website 160 service.

The mobile app 120 syncs with the backend 170 server for maintenance items. If there are outstanding maintenance items on a vehicle 130 or trailer 140, the driver 110 is alerted in the app 120 when they enter a matching vehicle 130 ID or trailer 140 ID in the mobile app 120 during their DVIR 1500. Upon discretion of the company, the driver 110 may be blocked from using the entered vehicle 130 or trailer 140s if issues persist which are considered risks. The safety and maintenance teams are alerted and may read reports to check DVIR 1500 items on vehicle 130s using the website 160 which displays the DVIR 1500 data collected from the mobile app. These website 160 users will have the option to block a driver 110 from using a particular piece of equipment including vehicle 130, trailer 140, etc through the website 160, which communicates over the Internet with the mobile app 120 and tell it to alert the driver 110 and block them from using that vehicle 130. In response, the driver 110 would has to change the vehicle 130 or trailer 140 ID to that which does not have outstanding safety or maintenance issues, etc.

Bidirectional communication around DVIR 1500

The maintenance or safety teams can communicate using the website 160 with the driver 110 on the mobile app 120 in order to provide inspection feedback to points including, but not limited to those previously mentioned, such as related to vehicle 130 or trailer 140 usability, safety, risk, etc. A driver 110 is able to also communicate using the mobile app 120 with the maintenance or safety teams on the website 160 about the inspection feedback, etc.

Maintenance Management Through Website 160

Upon notification of DVIR 1500 items that need attention whether from safety or maintenance, the company is able to manage the DVIR 1500 items through the website 160. The maintenance team, for example, can track the items that needed attention and resolve the items that were fixed or replaced. They can log what, when, where, and why items were replaced and associated these data inputs to each DVIR 1500 item necessary. This can eventually be done automatically for them by processes on a backend 170 server. The maintenance items can be forwarded to a third party service that deals with vehicle 130 maintenance management. This is done to generate repair orders (ROs) and schedule the vehicle 130 for maintenance. This third party maintenance service communicates directly with the fleet that owns the vehicle 130 for repairing the vehicle 130 until the repair is complete. Along the way, the RO status is provided to the website 160 through an API where the status will be kept in a database and provided for the website 160 users to see through the website 160 upon request for the RO status on one or more vehicle 130s that are under maintenance.

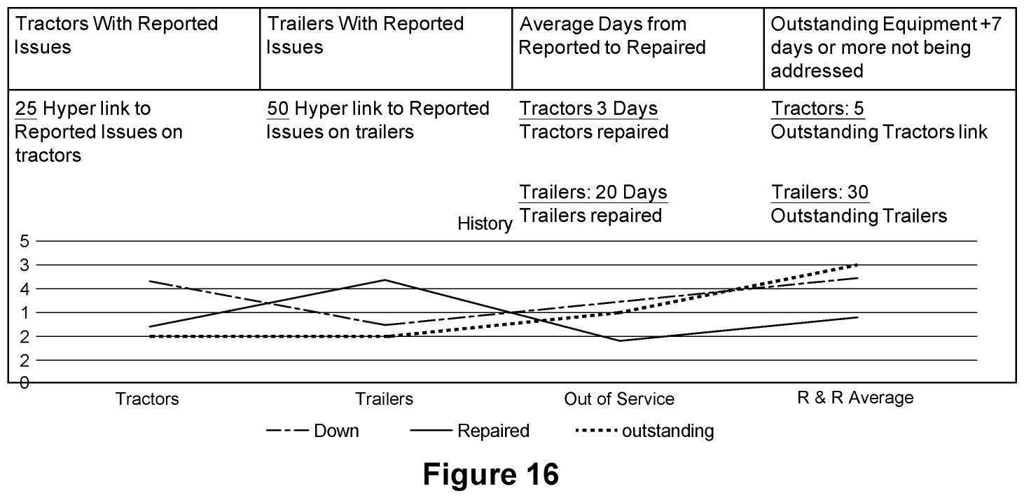

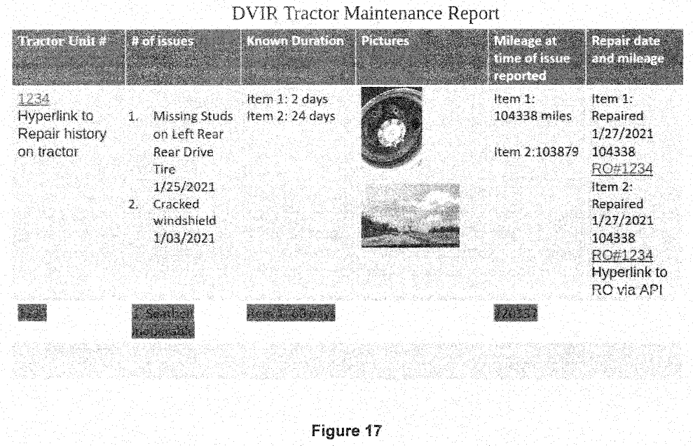

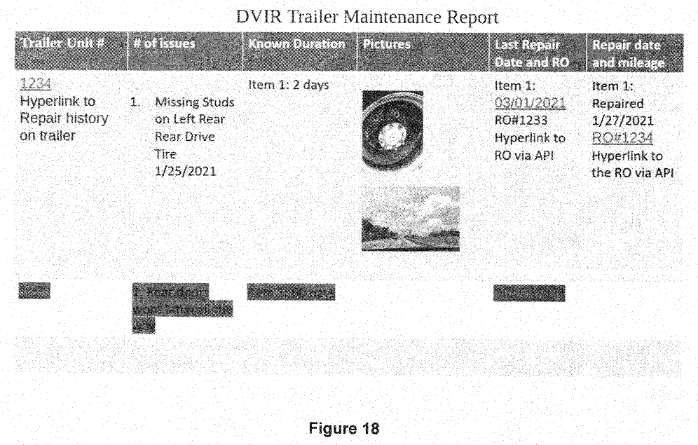

In FIGS. 16 and 17 and 18, an example set of maintenance dashboards is shown. These dashboards are available to users on the website 160. FIG. 16 shows a maintenance dashboard overview webpage example. The dashboard is intuitive, and there are hyperlinks from the overview page to other relevant pages, shown in FIGS. 17 and 18, that breakdown the tractor 130 and trailer 140 maintenance items into detail. The table depicted in FIG. 16 showcases useful maintenance numbers with associated hyperlinks that in the first row pertain to tractor 130s and in the second row pertain to trailer 140s. In FIG. 17, an example maintenance report dashboard webpage for the outstanding and repaired tractor 130 DVIR 1500 items is shown. In FIG. 18, an example maintenance report dashboard webpage for the outstanding and repaired trailer 140 DVIR 1500 items is shown.

FIG. 16 shows a maintenance dashboard overview example. This will be available to users on the website 160. As previously noted, there are hyperlinks from this page to other relevant pages that breakdown the items into detail. The first hyperlink 25 leads to another page of issues reported on tractor 130s (vehicle 130s) by way of DVIR 1500 in the mobile app. The second hyperlink 50 leads to another page of issues reported on trailer 140s by way of DVIR 1500 in the mobile app. The next hyperlink is “Tractors: 3 Days” which upon click goes to a page showing repaired tractors 130 and relevant information. The next hyperlink “Trailers: 20 Days” leads to another page showing repaired trailers 140 and relevant information. In the rightmost column, “Tractors: 5” link leads to the outstanding tractors 130 page upon click, which shows the tractors 130 that have needed service for a period greater than or equal to 7 days. The “Trailers: 30” link leads to the outstanding trailers 140 page, showing trailers 140 that need repair over a 7+ day period. The chart at the bottom of the Figure displays the number of equipment that was down, repaired, or outstanding throughout history.

FIG. 17 shows the example maintenance report dashboard webpage for the outstanding and repaired tractor 130 DVIR 1500 items as is shown on the website 160. It includes the tractor 130 ID with a hyperlink to a webpage that shows the repair history of the tractor 130, the number, description and date of issues reported, duration of issues, pictures of issue items on the tractor 130 take by the driver 110 using the mobile app, the mileage and date of repairs and hyperlinks to repair orders (ROs) that were completed for the issues.

FIG. 18 shows the example maintenance report dashboard webpage on the website 160. It includes the trailer 140 ID with a hyperlink to a webpage that shows the repair history of the trailer 140, the number, description and date of issues reported, duration of issues, pictures of issue items on the tractor 130 taken by the driver 110 using the mobile app, the last repair dates and hyperlinks to previous ROs that were completed, and the mileage and date of new repairs associated with current issues and hyperlinks to repair orders (ROs) that were completed for the issues.

Then, when the vehicle 130 or trailer 140 associated with the issues were fixed and ready to use, the mobile app 120 is synced with this status automatically over the Internet so that the vehicle 130 or trailer 140 is usable by a driver 110 within the mobile app. The maintenance and safety teams can then keep their fleet healthy and increase uptime drastically by using the embodied invention compared to existing ELD exempt solutions.

Linking Drive times to ECM times from Vehicle OEM Clouds via APIs

The driver 110 drive times can later be linked to data from vehicle 130 ECMs (electronic Control Modules) through APIs (Application Programming Interfaces). Vehicle 130 OEM (Original Equipment Manufacturers) providers may collect data from vehicle 130s driven by drivers 110 who also use the mobile app 120 which collects their duty and drive times. The OEM collected vehicle 130 usage data includes, but is not limited to, location, timestamp, vehicle 130 speed, etc. These times can be synced with the OEM vehicle 130 data collected while the driver 110 was driving to accomplish, in a way, what the ELD rule accomplishes by using an on-vehicle 130 device. Instead of using a device attached to the vehicle 130 ECM while the driver 110 is driving, the mobile app 120 data collected from the driver 110's mobile device can be synced with a separate set of data collected from the driven vehicle 130's ECM as provided by an OEM provider API. The OEM producers of the vehicle 130 may collect vehicle 130 data such as timestamp, location, engine speed, vehicle 130 speed, braking pressure, etc when the driver 110 is driving and provide this data through one or more APIs. Our solution can connect to said APIs to pull data and associate said data with the mobile app 120 data. This will provide the fleets and regulators with more confidence in the accuracy of the driver 110 data if needed for regulatory compliance, etc.

Data Collected and Sent

More data is more useful and allows more insights. Every important part of the drivers 110 history matters to the fleet for risk management in the hiring process. If the fleet cannot see a certain important piece of information that was covered up, then they could be making a poor judgment in hiring a driver 110. The driver 110 may have gone out of compliance with the ELD exempt rule, missed a way station, etc. The backend 170 database may contain, collect, or provide data related to the drivers 110 from the app 120 along with other data related to the driver 110 or similar types of drivers 110 from other fleets. The website 160 and the backend 170 services associated with the website 160 and backend 170 database may pull data such as from OEM or critical event data providers into the database. Data is securely pushed to or pulled from other services that the fleets need or use for load management, dispatching, equipment management or maintenance, route creation and management, risk management, insurance providers, Department of Motor Vehicle 130s (DMV), police records, traffic records, etc. The driver 110 data collected from the app 120 can be associated with, added to, or compared with this data, for example. Insurance companies, for example, can provide data about a driver 110 and we can help create a risk profile for the fleet associated with that driver 110 based on past data, etc.

Driver Risk Profile

A driver 110 risk assessment system is developed upon the collected driver 110 data. One or more measurements is calculated by the solution to create the assessment. The assessment and a way to customize the assessments is provided to the company using the website 160 mentioned herein. The assessments are generated by machine learning algorithms that may assign scores based on factors such as, but not limited to, critical event reporting data from third party providers, driving data collected from the mobile app, motor vehicle 130 records collected from the department of transportation (DOT) or DMV, records from insurance companies, or other useful data points collected by the mobile app 120 or one or more third party providers pertaining to the driver 110 that can affect their risk assessment, etc. Measurements calculated may include correlations or percentiles as compared with a population distribution of drivers 110 as collected through the mobile app 120 or a third party service, standard deviation or variance in driving data relative to prior history, etc. The assessment can be prepared as a report delivered with various factors outlined that showcase the risk associated with one or more particular drivers 110 as compared to the drivers 110 from their own fleet or from one or more fleets that belong to a similar fleet type by using anonymized data based on their current and past driving history as collected using the mobile app. Any fleet would then be able to compare their drivers 110 to drivers 110 from other fleets with the same type of hauling application as their fleet. Some examples of hauling applications that the fleets might use are LTL, flatbed, dry van, reefer, etc. In the risk assessment, the drivers 110 from an LTL fleet, for example, can then be compared for risk against drivers 110 from other LTL fleets that use the solution to collect data.

Cryptocurrency

A cryptocurrency (crypto) is created or used that represents payment for reward from using the mobile app 120 to collect data to the blockchain. The crypto is used in a marketplace provided through the app 120 or website 160. The crypto may also be held in a wallet and transferred. This cryptocurrency is used to pay for access to driver 110 data on the blockchain. The crypto is accumulated in a wallet by drivers 110 who use the mobile app. The drivers 110 can earn cryptocurrency for completing above and beyond inspections, driving within their ELD exempt criteria consistently over a period of time, completing training modules in the mobile app, etc. The crypto is used to pay for goods from a truck stop that accepts the crypto, an online marketplace such as Amazon that accepts the crypto, etc.

FIG. 21 shows the flowchart block legend 2100 for the process flows with the different block shapes and shadings for starting points 2102, ending points 2104, user steps 2106, decision points, 2108, and internal computer processes 2110.

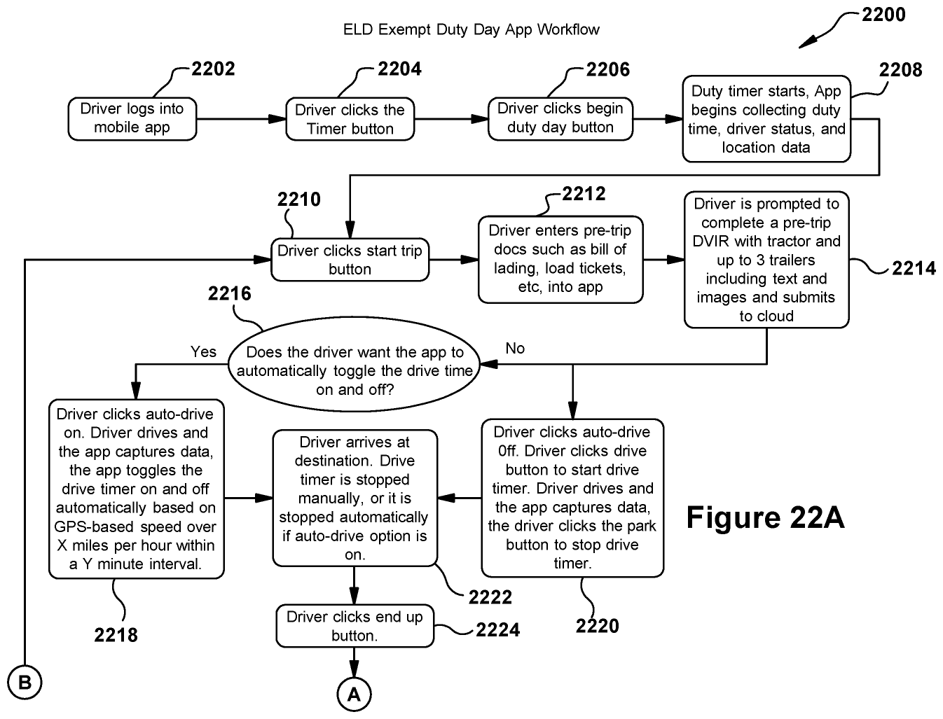

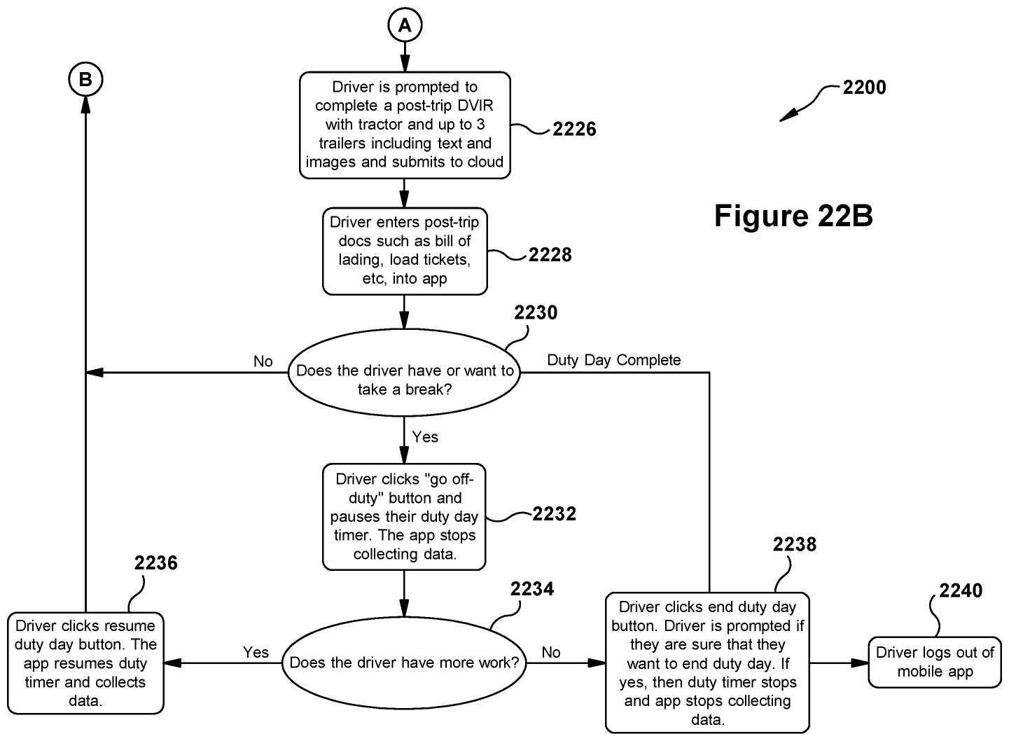

FIGS. 22A and 22B show the ELD exempt duty day app workflow process 2200. The driver logs in 2202, starts the timer 2204, starts the duty day 2206, the system logs the information 2208 including the location data. Next, the driver starts a trip 2210, enters the pre trip documents 2212 such as a bill of lading, load tickets, etc. into the application and is then prompted 2214 to complete the pre-trip DVIR for the tractor and one or more trailers which is uploaded including any entered text or images to the system database. The driver can then select 2216 whether to have the application toggle the drive timer on and off. If the application drive logging is toggled on 2218, then the system collects drive time based on global positioning system information for speed over a time duration. If the application drive logging is toggled off 2220, then the driver will be responsible for toggling the drive timer off. Once the driver arrives at the destination the timer is stopped 2222 and the driver can end the trip 2224. At the end of trip, the driver is prompted 2226 for a post trip DVIR for the tractor and trailers. The end of trip documents are also entered 2228 and the driver is prompted for a break or end of duty day 2230. If no break is selected then the app return to the start of a trip 2210. If a break is selected then the duty day timer is paused 2232 and the application waits for an indication of more work 2234. If more work is selected, then the app resumes the duty day timer and data collection 2236 and returns to the start of a trip 2210. At either the end of a duty day from break decision 2230 or at the indication of no further work 2234 the driver confirms 2238 an end of duty day selection to stop the duty timer and data collection. The driver can then log out of the application 2240.

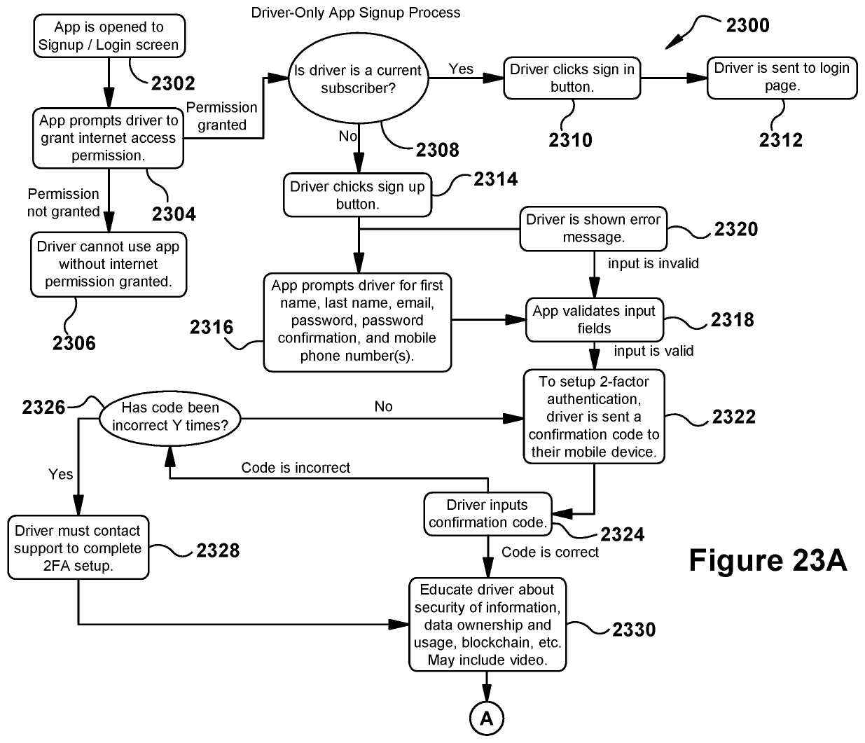

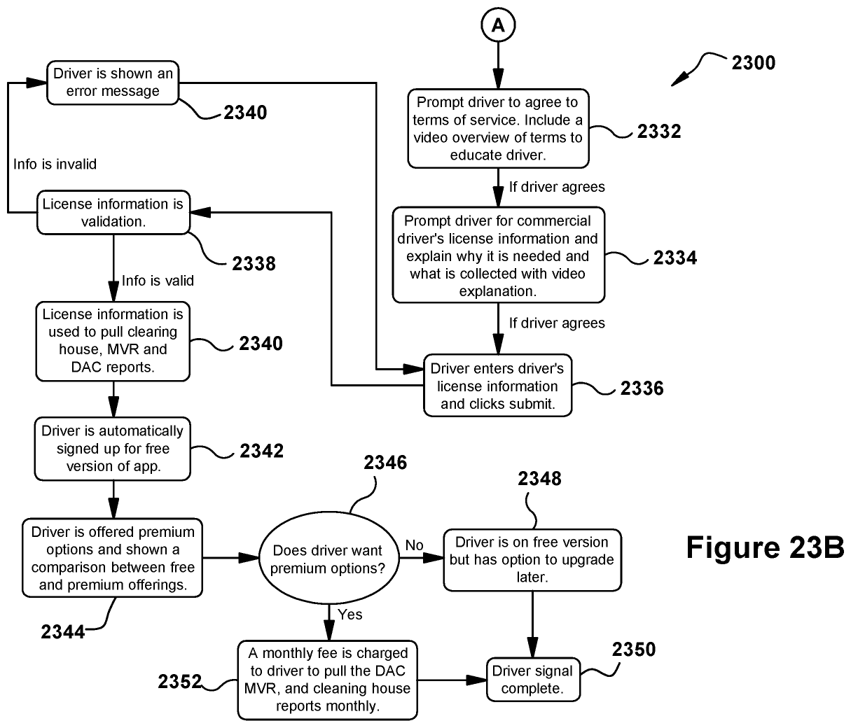

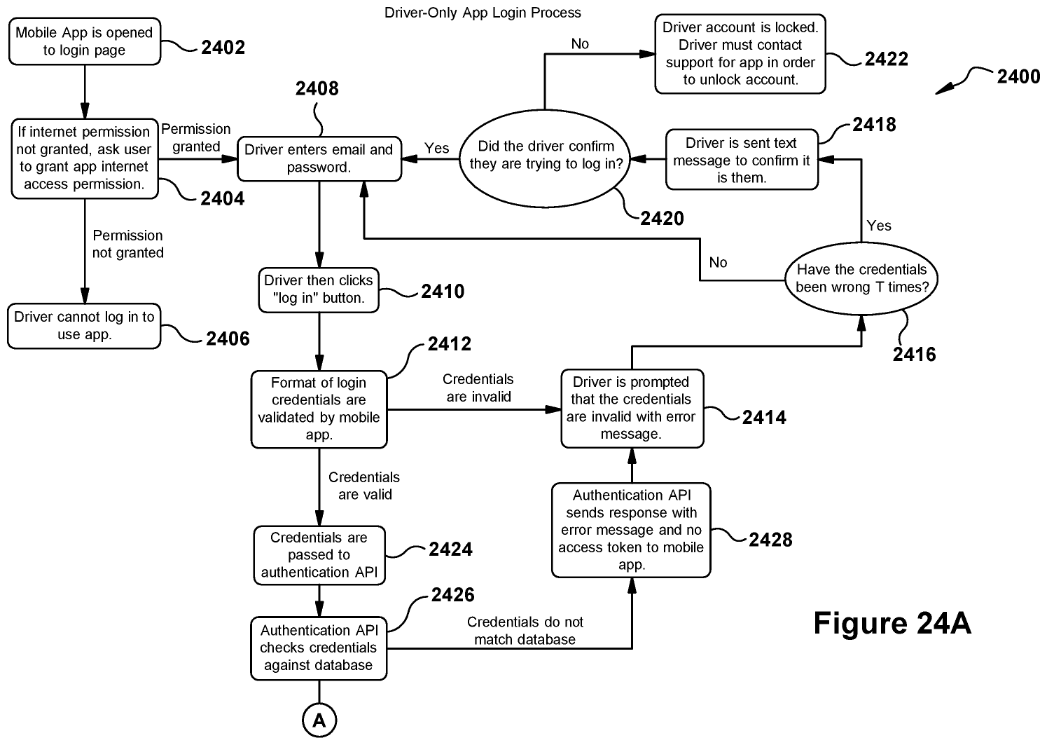

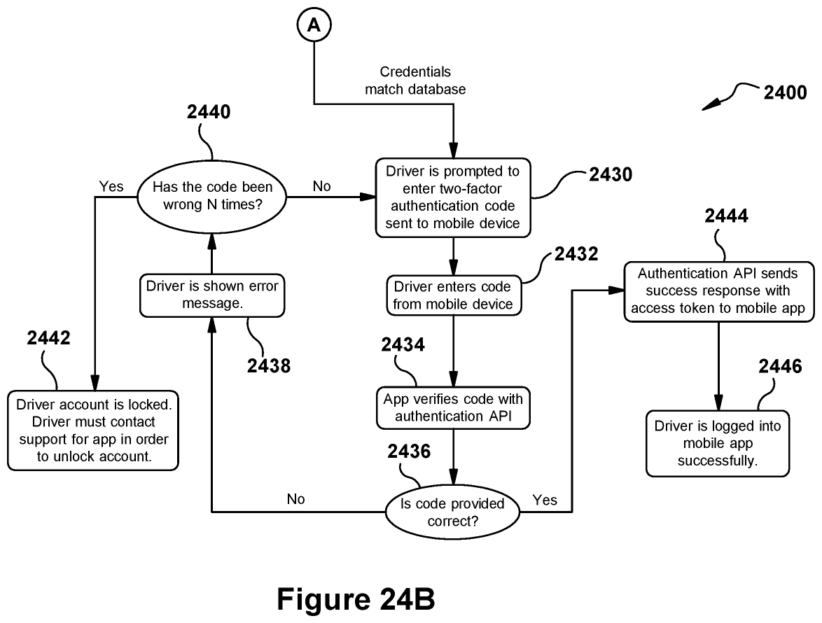

FIGS. 23A and 23B show shows the independent driver signup process 2300. Note that the independent driver can sign up either through the app or the website such that the following process can be implemented on either platform with the appropriate adaptations. The app opens to the login screen 2302 and requests internet access 2304 when necessary. If permission is denied 2306 the app notifies 2306 the driver that it cannot continue and provides another opportunity for access. once permission is granted the app asks whether the driver is a current subscriber 2308. If the driver is a current subscriber, then a sign in button is provided 2310 and the driver is sent to the login page 2312 in FIGS. 24A and 24B. If the diver is not a subscriber, then the driver is prompted to sign up 2314 and enter information 2316 including first name, last name, email, password and confirmation, and mobile number. The input is checked 2318 for validity. If the input is invalid an error message is shown 2320 and the driver is prompted for new input. If the input is valid, then a confirmation code for two factor authentication is sent 2322. Once the code is entered it is checked 2324. If the code is incorrect a counter is incremented and check for number of invalid codes on this entry period 2326. If the maximum number of incorrect entries is not exceeded then the driver is prompted to reenter the code 2322. If the maximum number is exceeded the driver is prompted 2328 to contact support. Once the driver is in the system they are educated 2330 about information security, data ownership and usage, blockchain, etc. and prompted 2332 to agree to the terms of service 2332. The system will not continue until agreement is received. The driver is then prompted 2334 for commercial driver's license information with an explanation for the need for this information. Once the information is entered 2336, the license information is checked 2338 for validity. Bad information results in a error display 2340 and prompting for corrected information 2336. Valid information lets the system pull clearing house, MVR, and DAC reports and the free version of the app is accessed 2342. The driver is prompted for an upgraded version 2344 and the response is checked 2346. If the upgraded version is not selected, then the driver is provided access to the free version 2348 and the signup is complete 2350. If the driver selected the upgrade, then a monthly fee is set in place 2352 and the driver has access to monthly updates of the pulled reports and the signup is complete 2350.

FIGS. 24A and 24B show the independent driver app login process 2400. The app is opened 2402 to the login page and requests internet access 2404 when necessary. If permission is denied 2406 the app notifies 2306 the driver that it cannot continue and provides another opportunity for access. Once permission is granted the app requests 2408 email and password and the driver enters the login button 2410 and the credential format is validated 2412. If the format is invalid, the driver is notified 2414 and the number of entries attempts is checked 2416 to see if it exceeds a maximum allowable. If within the number of allowed attempts, the driver is prompted for new information 2408. If the driver has exceeded the number of attempts 2418, then a secondary communication 2418 is sent for confirmation of identity 2420. If the driver confirms, then they are allowed to reenter information 2408. If the driver does not confirm, then the account is locked 2422 and a call into support is required. Once the format is valid 2412, the credentials are passed to authentication 2424 and checked 2426 for validity against the database. If the credentials do not match the database then an error message is sent 2428 and the driver is notified 2414. If the credentials match the database, then two factor authentication is sent 2430, entered by the driver 2432, received 2434 and checked 2436. If the authentication code is invalid then an error is displayed 2438. checked for maximum allowable misentries 2440 and the driver is either prompted for a new entry 2430 or the account is locked 2442 when the maximum number of bad entries is received. If the authentication code is provided correctly, then the app is provided access 2444 and the login is successful and complete 2446.

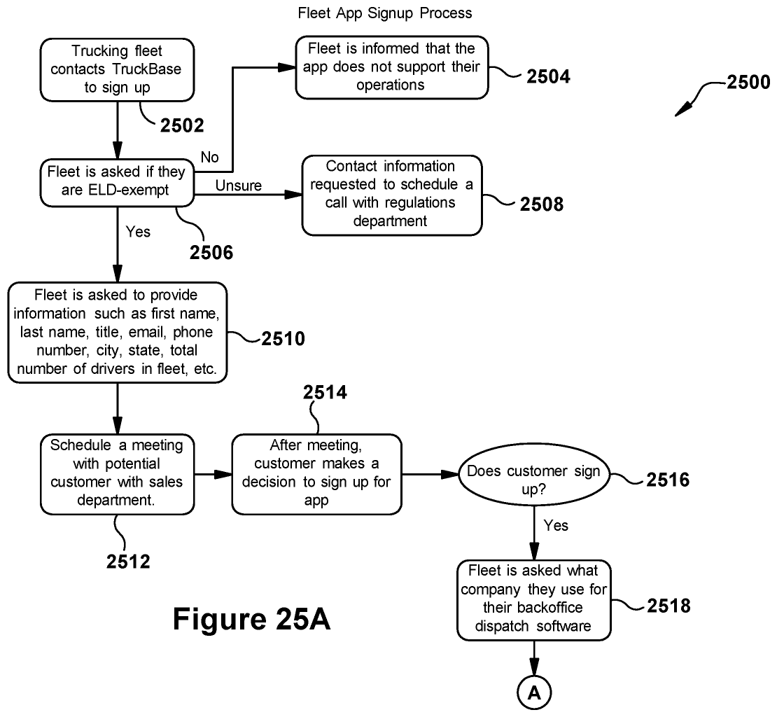

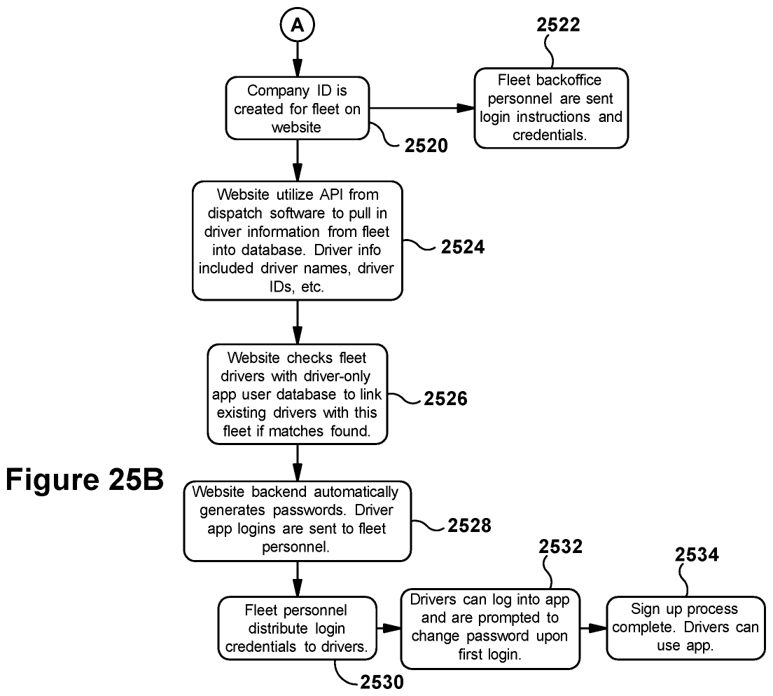

FIGS. 25A and 25B show the fleet app signup process 2500. The fleet contact requests a signup 2502 and they are asked if the company is ELD exempt 2506. If not exempt, they are informed 2508 that the app does not support their operations. If unsure, they are directed to contact the regulations department 2508. If they are ELD exempt, the fleet is asked 2510 to provide first name, last name, title, email, phone number, city state, number of drivers, etc. and a meeting is scheduled with the sales department 2512. If the fleet customer decides 2514 to sign up and requests access to the app 2514, the fleet is asked for backoffice dispatch software 2518 for compatibility, the company identifier is created 2520, login instructions are sent to backoffice personnel 2522, an API pulls driver information into the database such as names, identifications, etc. and links existing drivers with the fleet 2526 and then generates passwords 2528 and sends them to fleet personnel for distribution 2530 to drivers to login and change passwords 2532 to complete the signup process 2534.

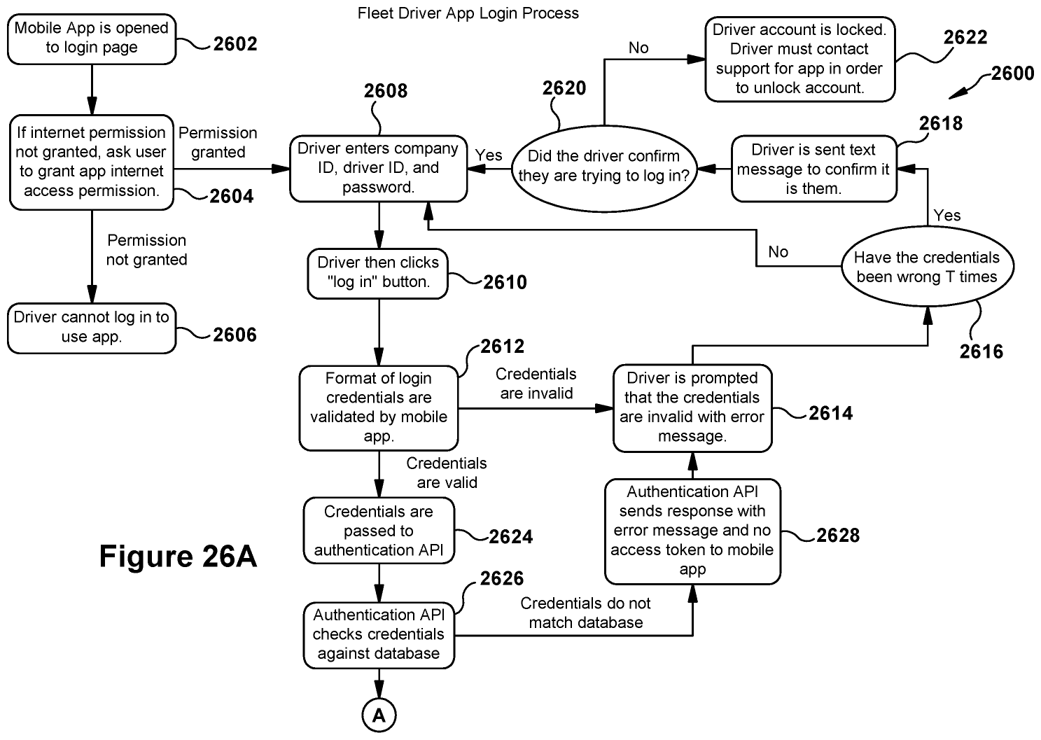

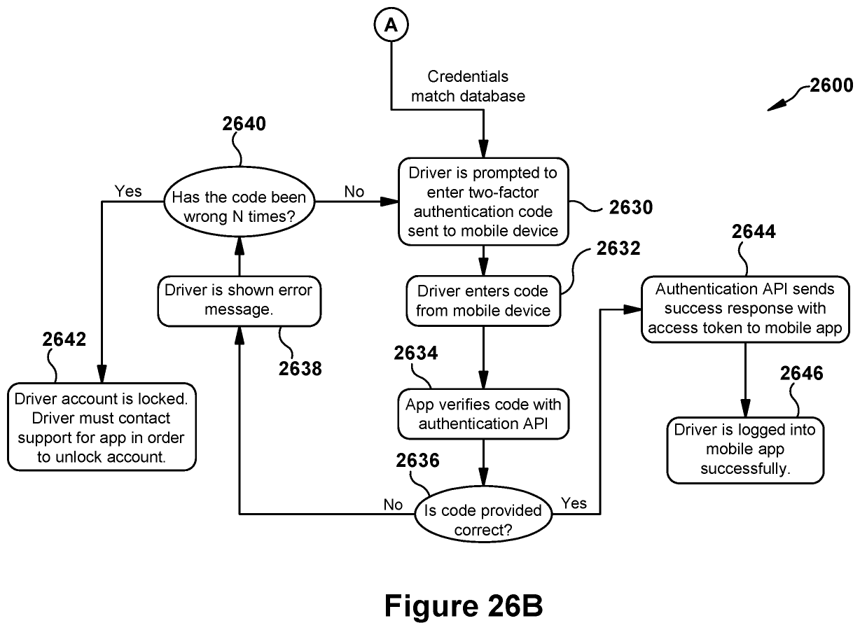

FIGS. 26A and 26B show the fleet driver app login process 2600. The app is opened 2602 to the login page and requests internet access 2604 when necessary. If permission is denied 2606 the app notifies 2306 the driver that it cannot continue and provides another opportunity for access. Once permission is granted the app requests 2608 email and password and the driver enters the login button 2610 and the credential format is validated 2612. If the format is invalid, the driver is notified 2614 and the number of entries attempts is checked 2616 to see if it exceeds a maximum allowable. If within the number of allowed attempts, the driver is prompted for new information 2608. If the driver has exceeded the number of attempts 2618, then a secondary communication 2618 is sent for confirmation of identity 2620. If the driver confirms, then they are allowed to reenter information 2608. If the driver does not confirm, then the account is locked 2622 and a call into support is required. Once the format is valid 2612, the credentials are passed to authentication 2624 and checked 2626 for validity against the database. If the credentials do not match the database then an error message is sent 2628 and the driver is notified 2614. If the credentials match the database, then two factor authentication is sent 2630, entered by the driver 2632, received 2634 and checked 2636. If the authentication code is invalid then an error is displayed 2638, checked for maximum allowable misentries 2640 and the driver is either prompted for a new entry 2630 or the account is locked 2642 when the maximum number of bad entries is received. If the authentication code is provided correctly, then the app is provided access 2644 and the login is successful and complete 2646.

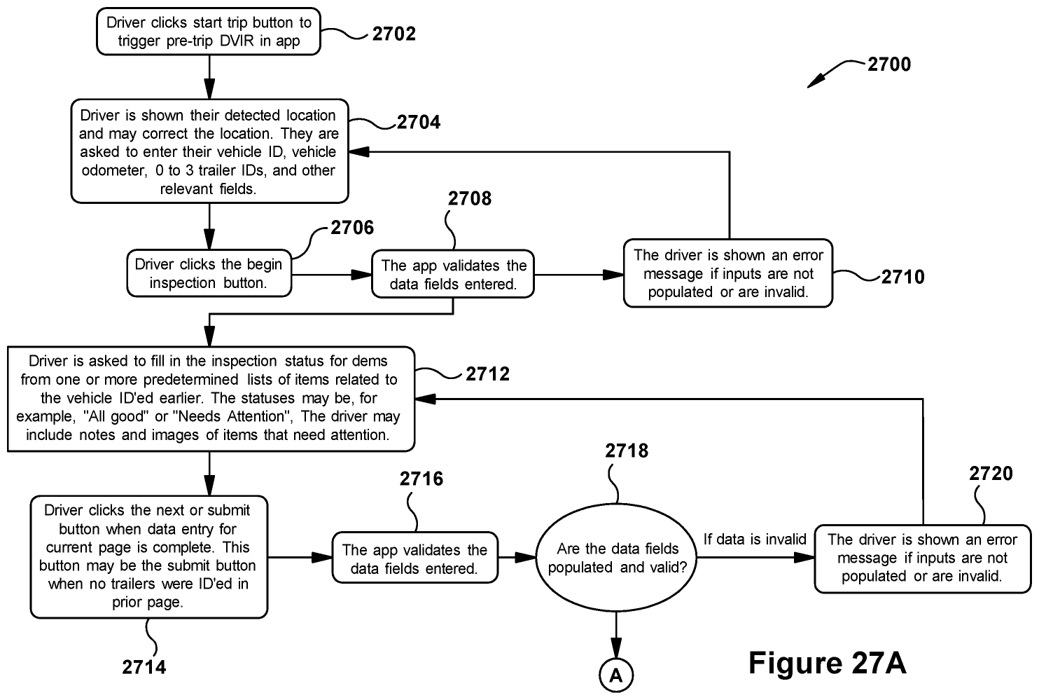

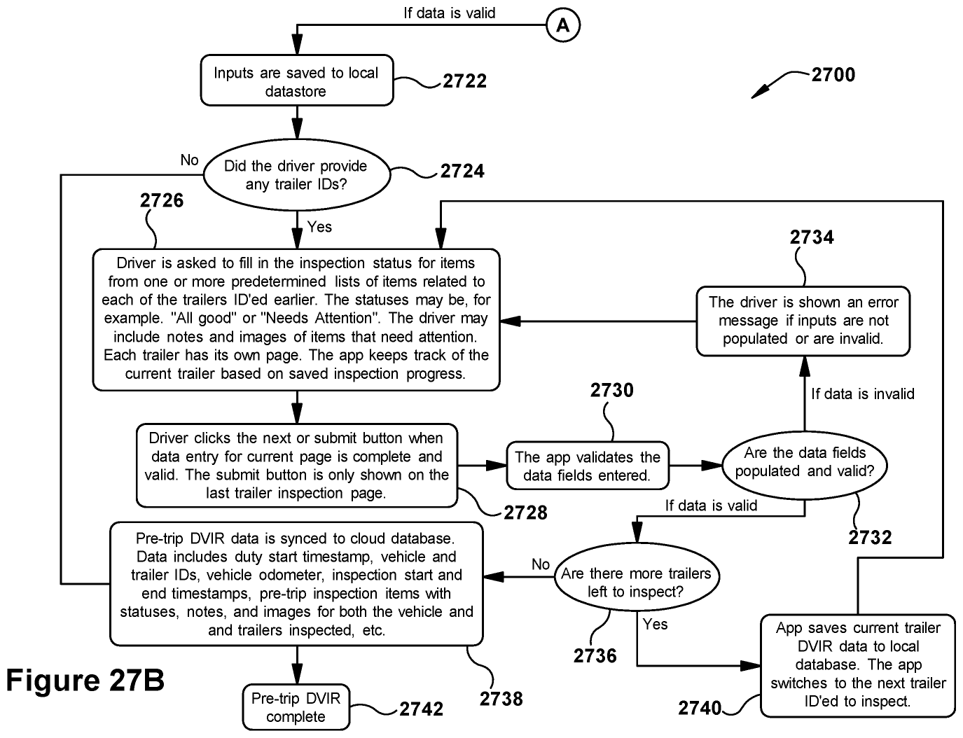

FIGS. 27A and 27B show the pre trip DVIR process 2700. The driver starts the trip 2702, confirms location, vehicle identification, odometer, trailer identification(s), and other information. The driver selects to start the inspection 2706 and the app validates the initial information 2708. If the initial information is invalid, and error 2710 is shown and the driver is asked to reenter the information. One the initial data is validated, the driver is prompted 2712 for each of the inspection items for that vehicle such as good/need attention/notes/images and the information is submitted 2714, validated 2716, and checked for completeness 2718. If the information is incomplete, the driver is prompted to correct the error 2720. If the information is complete, the inputs are populated to the local database 2722 and the system looks to see if trailer identifications were provided. If a trailer identification was provided the driver is prompted 2726 for each of the inspection items for that trailer such as good/need attention/notes/images and the information is submitted 2728, validated 2730, and checked for completeness 2732. If the information is incomplete, the driver is prompted to correct the error 2734. If the information is complete, the system checks for more trailers 2736, saves the entered trailer data 2740 and updates to the next trailer for inspection. If no trailer identifications were provided, or if all of the trailer information has been entered, the information is sent to the backend cloud database with duty start timestamp, vehicle and trailer IDs, odometer, inspection start and end timestamps, pre-trip inspection items, statuses, notes, images, etc. The pre trip DVIR is then complete 2742.

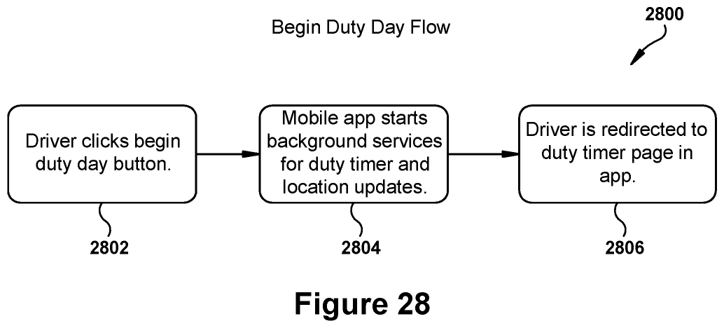

FIG. 28 shows the begin duty day process 2800. The driver click to begin duty day 2802, the duty timer is started and information capturing is initiated 2804, and the driver is redirected to the duty timer page 2806.

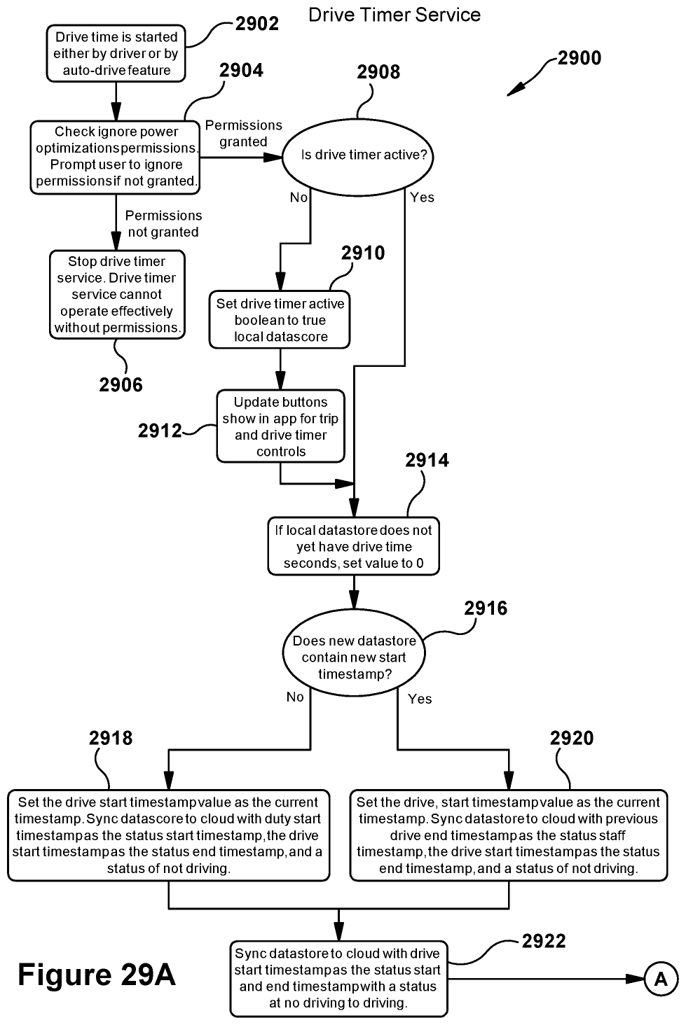

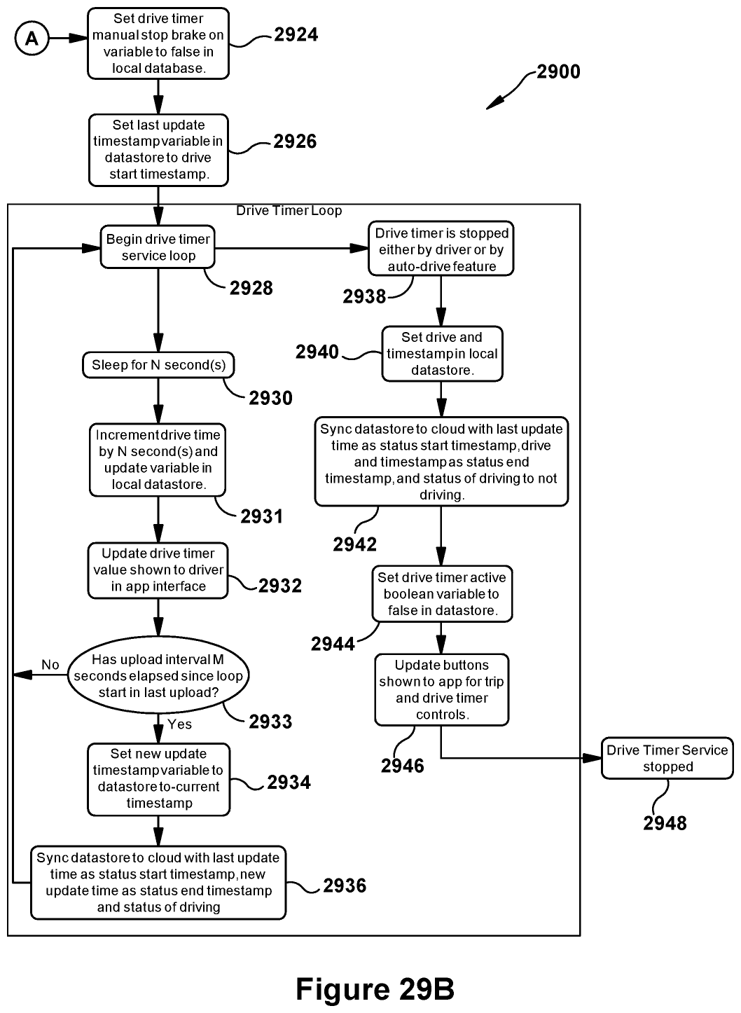

FIGS. 29A and 29B show the drive timer service process 2900. The duty timer is started 2902 by either the driver or the auto drive feature. The driver is prompted 2904 to allow the app to ignore power optimizations to maintain accuracy. If power optimization override is required, an error message is provided 2906 and the drive timer service is halted until permission is given. Once power optimization override is provided, the app looks to see if the drive timer is active 2908. If the drive timer is not active, the drive timer is activated 2910, the screen display is updated 2912 for trip and drive timer controls, and the database is checked for drive time 2914 and reset if needed. If the drive timer is active, the database is checked for drive time 2914 and reset if needed. The local database is then checked 2916 for the drive start timestamp. If no timestamp is active, then the drive stamp is set 2918, the database is synced with the web database, the duty start timestamp is set as the status start timestamp, the drive start timestamp is set as the status end timestamp and the not driving status is entered. If a timestamp is active, then the drive start timestamp is set 2920 as the current timestamp, the database is synced with the web database with the previous drive end timestamp as the status start timestamp, the drive start timestamp is set as the status end timestamp, and the not driving status is entered. The cloud database is then synced 2922 with the drive start timestamp as the status start and end timestamps with a not driving status. Next, the drive timer manual stop boolean variable is set 2924 to false in the local database, and the last update timestamp variable is set to the drive start timestamp 2926. The drive timer service loop is then started 2928. The drive timer service loop sleeps 2928, updates the drive time 2931, updates the drive timer shown to the driver 2932 and then questions when the last upload was sent 2933. If the upload is recent, then the loop continues, but if the upload is due, a new update timestamp is set to the current timestamp 2934, the cloud database is synced with the last update time as status start timestamp, the new update time as the status end timestamp and the status of driving is set 2936, and the loop continues. Once the timer and loop is stopped 2938, the drive end timestamp is set 2940, the cloud database is synced with the last update time as the status start timestamp, the drive end timestamp set as the status end timestamp, and the status is set to not driving 2942. The drive timer is then turned off 2944, the available selections for the driver are updated 2946 for the trip and drive timer controls, and the drive timer service is stopped 2948.

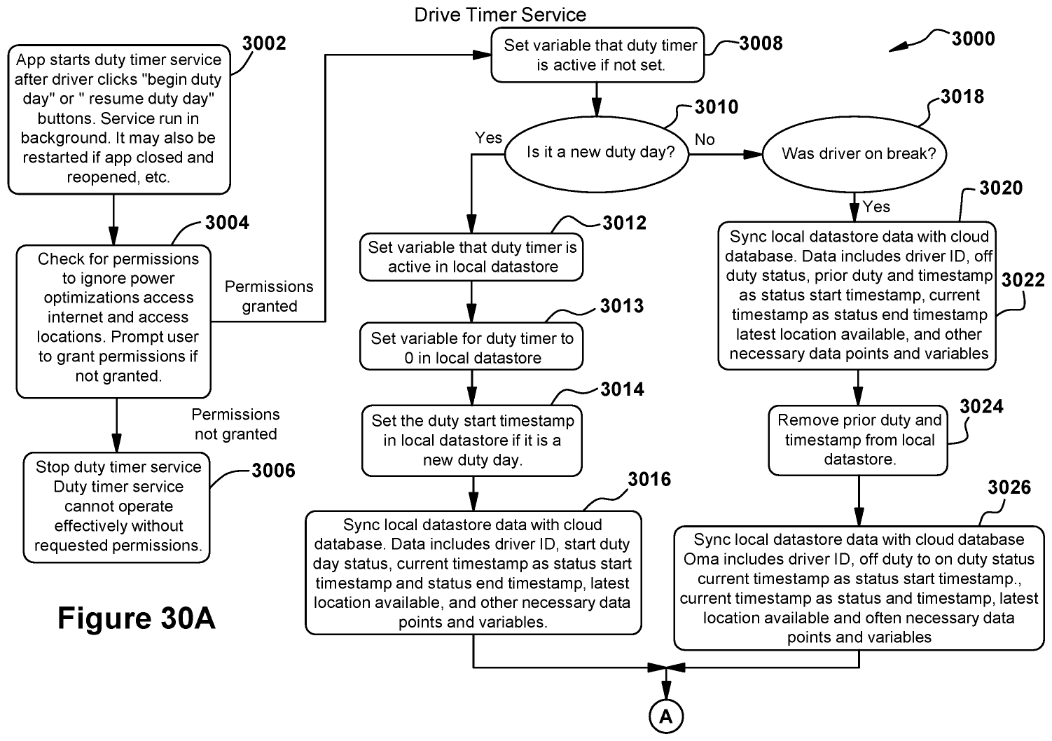

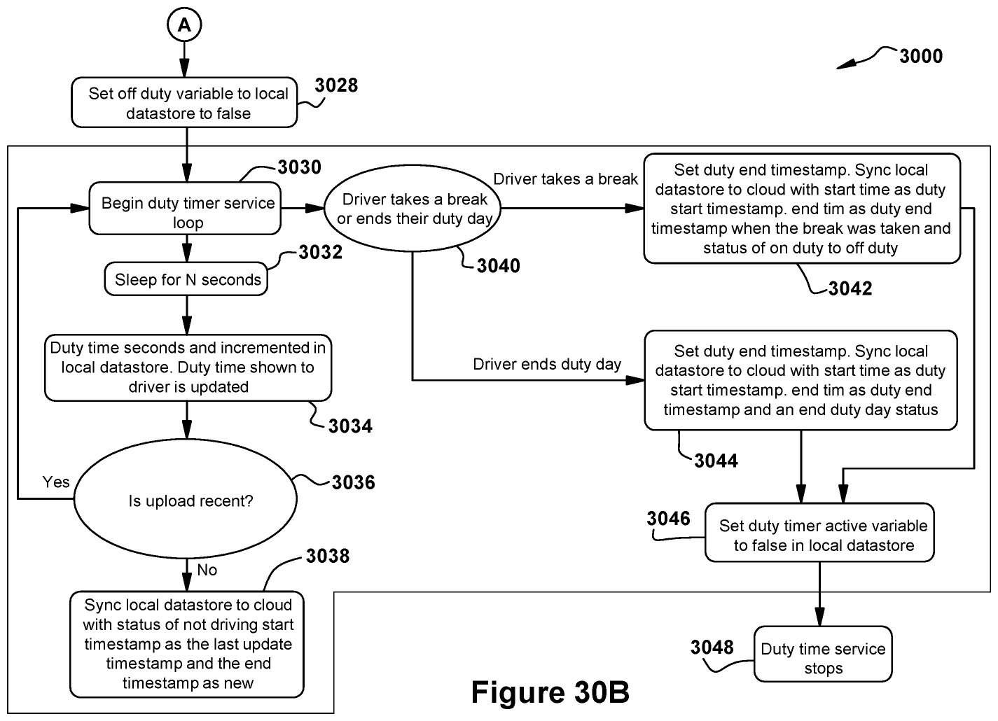

FIGS. 30A and 30B show the duty timer service process 3000. The driver begins or resumes the duty day 3002 and the driver is prompted 3004 to allow the app to ignore power optimizations to maintain accuracy, and provide internet access for data updates and location services. If these accesses are not provided, an error message is provided 3006 and the duty timer service is halted until permission is given. Once the necessary access is provided, the app looks to see if the duty timer is active 2908 and activates it if necessary. The system checks to see if it is a new duty day 3010. If it is a new duty day the app activates the duty timer 3012, initiates the variable 3013, sets the start timestamp 3014, syncs the local and website databases 3016 with driver ID, start duty status, current timestamp, status tart timestamp, status end timestamp, location, and other data points and variables before setting the off duty variable to false 3028. If it is not a new duty day the app check for if the driver was on break 3018, syncs the local and website databases 3016 with driver ID, off duty status, prior duty end timestamp as the status star timestamp, current timestamp as the status end timestamp, location, and other data points and variables, removes the prior duty end timestamp 3024, and then syncs the local and website databases 3026 with driver ID, on duty status, current timestamp as the status start timestamp, current timestamp as the status end timestamp, location, and other data points and variables before setting the off duty variable to false 3028. The app then begins the duty timer service loop 3030. The duty timer service loop sleeps 3032, updates the duty time 3031, updates the duty timer shown to the driver 3034 and then questions when the last upload was sent 3036. If the upload is recent, then the loop continues, but if the upload is due, a new update timestamp is set to the current timestamp 3034, the cloud database is synced 3038 with the status of not driving, start timestamp as the last update time, and the current timestamp as the end timestamp and the loop continues. Once the timer and loop is stopped 3040 the driver is asked if this is a break or end of day, if a break the duty end timestamp is set 3042, the cloud database is synced with the start time as the duty start timestamp, the end time as the duty end timestamp, the time the break was taken, and the off duty status is set. If this is end of duty day, the duty end timestamp is set 3044, the cloud database is synced with the start time as the duty start timestamp, the end time as the duty end timestamp, and the end of duty day status is set. For either a break or end of day, the duty timer is turned off 3046 and the duty timer service stops 3048.

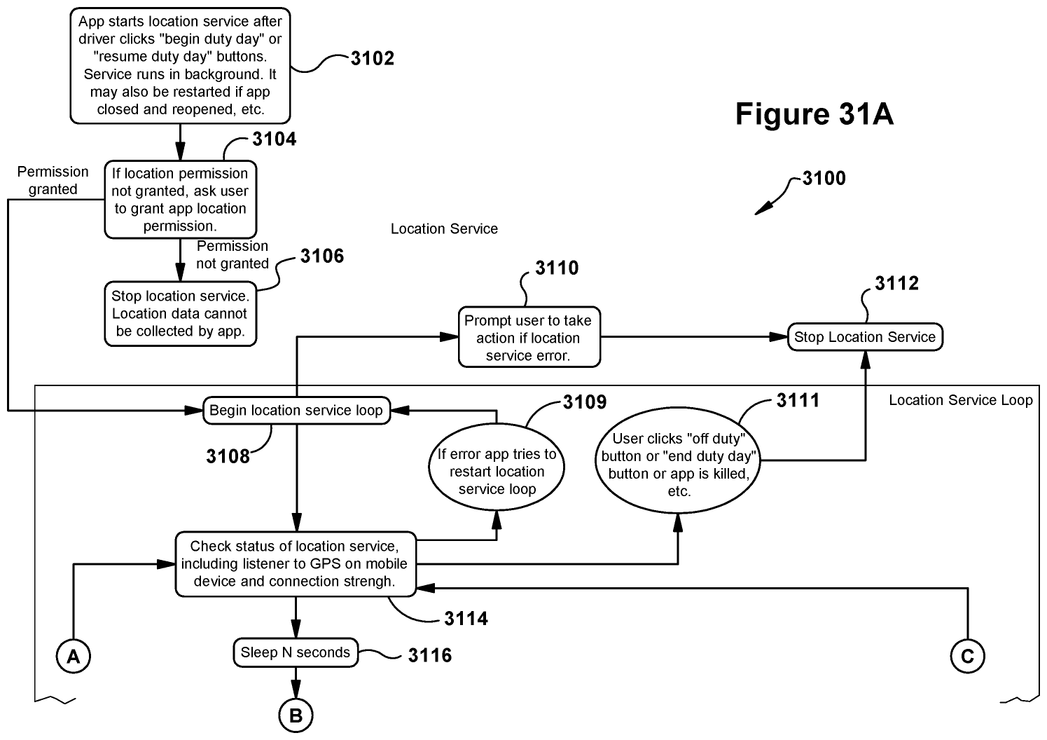

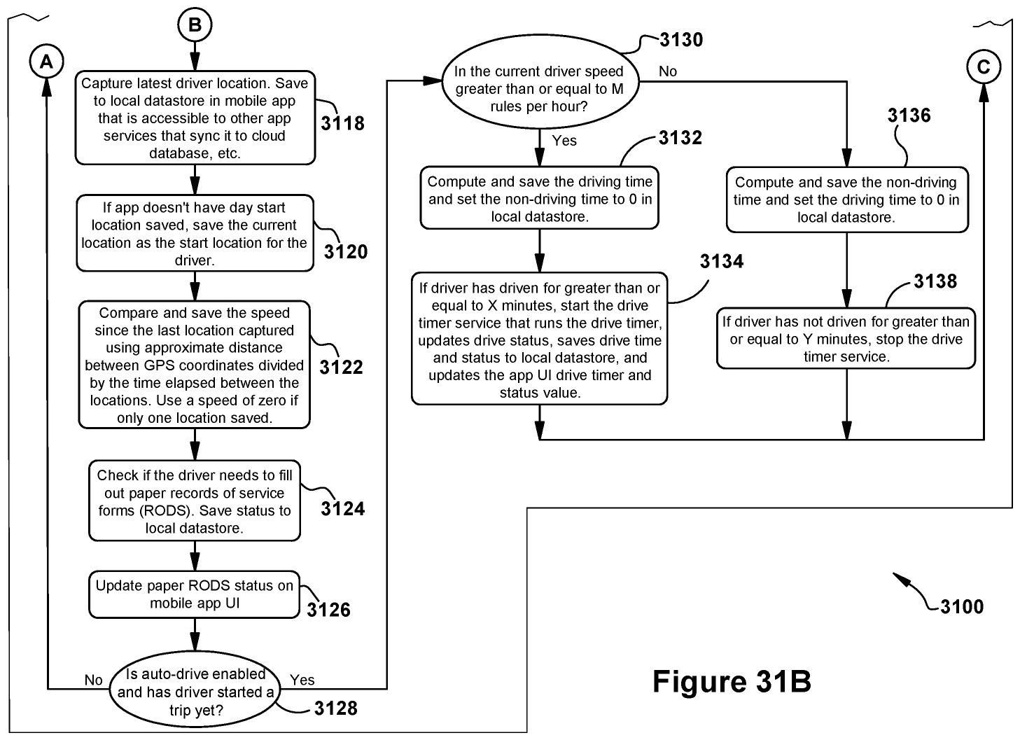

FIGS. 31A and 31B show the location service process 3100. The application starts 3102 the location service after the driver begins or resumes the duty day. This location service runs in the background and will restart if the app is closed and reopened. The driver is prompted 3104 to allow location services. If these accesses are not provided, an error message is provided 3106 and the location service is halted until permission is given. Once the necessary access is provided, the app begins 3108 the location service loop. If at any point in the loop there is a location service error, the driver is prompted 3110 with an error message and the service is halted 3112. If at any point in the loop the driver changes 3111 status to off duty, end of duty day, or cancellation of the application, the service is halted 3112. Under proper operation, the location service will monitor the status of the location service, GPS position, and connection strength and should an error occur in these parameters, the location service loop will attempt to restart 3109 a number of times until it is determined that the problem cannot be fixed. Once started, the location service loop sleeps 3114, captures location 3118, check to see if this is the duty day start location 3120, compute and save 3122 speed using changing GPS coordinates and elapsed time or simply enter a zero if only one location is found updates the duty time 3122, notify 3124 the driver is a paper record of duty service report is required and save that status to the local database and provide the requisite update on the drivers interface page 3126. The app then checks if autodrive is enabled and if not returns to check the location status 3114. If autodrive location service is enabled, then the system checks for driver movement 3130. If driver movement is found the app computes and saves 3132 the driving time and sets the local database nondriving time to zero. Upon movement for a minimum period 3134, the drive timer service is started to run the drive timer, the drive status is updated to driving, the drive time and status are saved in the local database and the user interface is updated with the appropriate values 3134 before returning to check location service status 3114. If no driver movement is found the app computes and saves 3132 the non driving time and sets the local database driving time to zero. Upon no movement for a minimum period 3138, the drive timer service is stopped before returning to check location service status 3114.

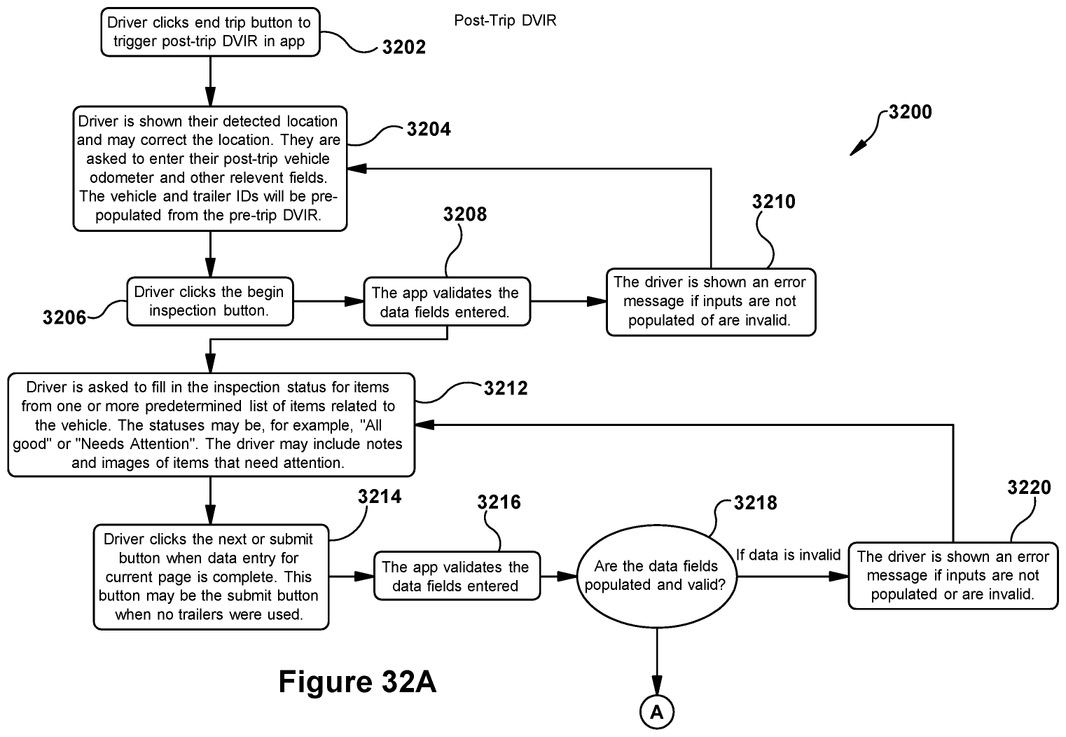

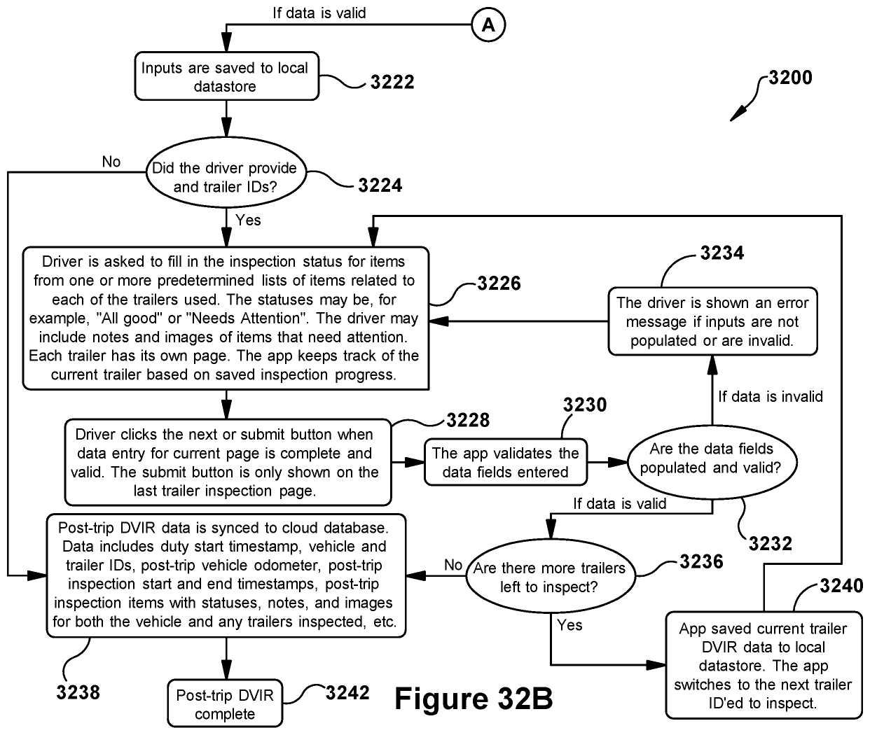

FIGS. 32A and 32B show the post trip DVIR process 3200. The driver ends the trip 3202, confirms location, vehicle identification, odometer, trailer identification(s), and other information. The driver selects to start the inspection 3206 and the app validates the initial information 3208. If the initial information is invalid, an error 3210 is shown and the driver is asked to reenter the information. One the initial data is validated, the driver is prompted 3212 for each of the inspection items for that vehicle such as good/need attention/notes/images and the information is submitted 3214, validated 3216, and checked for completeness 3218. If the information is incomplete, the driver is prompted to correct the error 3220. If the information is complete, the inputs are populated to the local database 3222 and the system looks to see if trailer identifications were provided. If a trailer identification was provided the driver is prompted 3226 for each of the inspection items for that trailer such as good/need attention/notes/images and the information is submitted 3228, validated 3230, and checked for completeness 3232. If the information is incomplete, the driver is prompted to correct the error 3234. If the information is complete, the system checks for more trailers 3236, saves the entered trailer data 3240 and updates to the next trailer for inspection. If no trailer identifications were provided, or if all of the trailer information has been entered, the information is sent to the backend cloud database with duty start timestamp, vehicle and trailer IDs, odometer, inspection start and end timestamps, pre-trip inspection items, statuses, notes, images, etc. The posttrip DVIR is then complete 3242.

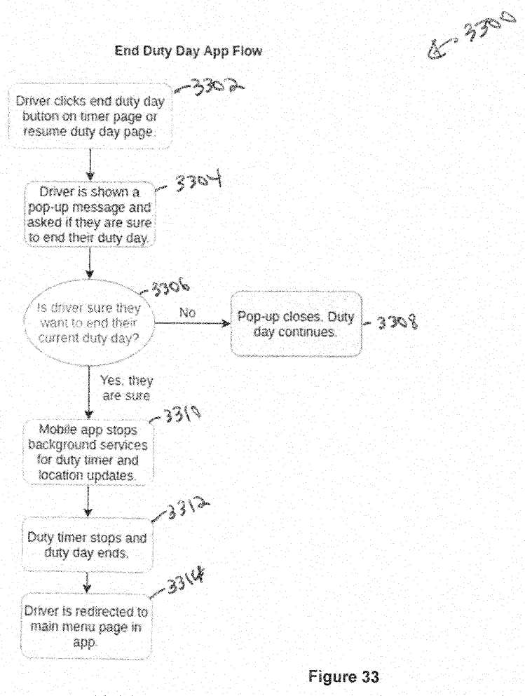

FIG. 33 shows the end duty day app flow process 3300. The driver clicks to end the duty day 3302 and is asked to confirm 3304. If the driver elects not to confirm, the duty day continues 3308. If the driver elects to end the duty day, then the app stops 3310 the background service such as the duty timer and location updates, stops the duty timer and ends duty day 3312, and redirects the driver to the main menu 3314.

From the foregoing, it will be seen that this invention well adapted to obtain all the ends and objects herein set forth, together with other advantages which are inherent to the structure. It will also be understood that certain features and subcombinations are of utility and is employed without reference to other features and subcombinations. This is contemplated by and is within the scope of the claims. Many possible embodiments are made of the invention without departing from the scope thereof. Therefore, it is to be understood that all matter herein set forth or shown in the accompanying drawings is to be interpreted as illustrative and not in a limiting sense.

When interpreting the claims of this application, method claims are recognized by the explicit use of the word ‘method’ in the preamble of the claims and the use of the ‘ing’ tense of the active word. Method claims should not be interpreted to have particular steps in a particular order unless the claim element specifically refers to a previous element, a previous action, or the result of a previous action. Apparatus claims are recognized by the use of the word ‘apparatus’ in the preamble of the claim and should not be interpreted to have ‘means plus function language’ unless the word ‘means’ is specifically used in the claim element. The words ‘defining,’ ‘having,’ or ‘including’ should be interpreted as open ended claim language that allows additional elements or structures. Finally, where the claims recite “a” or “a first” element of the equivalent thereof, such claims should be understood to include incorporation of one or more such elements, neither requiring nor excluding two or more such elements.

What is claimed is:

1. An electronic logging system for monitoring an air mile radius requirement and a regulated duty day time for a driver carrying a mobile device communicatively linked to record data in a database, the electronic togging system comprising:
an application software running on the mobile device capturing a duty day clock in time, a current time, a clock out time, a driver status, driving time, and duty time, a driver starting location, and a driver current location;
the application software checking compliance with an air mile radius requirement using the driver starting location and the driver current location;
the application software providing an alert when the driver is outside of the air mile radius requirement; and
the application software checking compliance with the duty day time using the a duty day clock in time, current tune, and clock out time, the application software providing an alert when the driver exceed the regulated duty day time.

2. The electronic logging system of claim 1, further comprising:
the application software generating a record of duty service when the duty day clock in to clock out period exceeds fourteen hours.

3. The electronic logging system of claim 1, further comprising:
the application soft wore generating a record of duty service when the driver location exceeds a one hundred and fifty air mile radius.

4. The electronic logging system of claim 1, further comprising:
the application software generating an exemption removal warning when a record of duty service is generated eight times in a period of thirty days.

5. The electronic logging system of claim 1, further comprising:
the application software prompting the driver for one or more vehicle and trailer inspection reports before trips.

6. The electronic logging system of claim 1, further comprising:
the application soft ware prompting the driver for one or more vehicle and trailer inspection reports after trips.

7. The electronic logging system of claim 1, further comprising:
the application software imaging and uploading documents.

8. The electronic logging system of claim 1, further comprising:
the application soft ware including messaging for load tickets.

9. The electronic logging system of claim 1, further comprising:
the application software providing two-way communication with a website user.

10. The electronic logging system of claim 1, further comprising:
the application associating a load ticket with a driver vehicle inspection report.

11. The electronic logging system of claim 1, further comprising:
the application associating a load ticket with a record of duty service.

12. The electronic logging system of claim 1, further comprising:
the application associating a load ticket with hours of service.

13. The electronic logging system of claim 1, further comprising:
the application associating a driver vehicle inspection report with a record of duty service.

14. The electronic logging system of claim 1, further comprising:
the application associating a driver vehicle inspection report with hours of service.

15. The electronic logging system of claim 1, further comprising:
the application associating a record of duty service with hours of service.

16. An electronic logging system, comprising:
providing a backend website and
viewing the collected driver data on the backend website.

17. An electronic logging system, comprising:
creating driver risk profiles using the collected driver data and/or critical events, other collected data.

18. An electronic logging system, comprising:
associating bills of lading with Duty day and/or DVIRs.

19. An electronic logging system, comprising:
associating DAC and/or drivers license information with duty day.

20. An electronic logging system, comprising:
providing an application platform allowing drivers to view and/or share their own data.

21. An electronic logging system, comprising:
providing an application platform linking a driver's cryptocurrency wallet to available rewards.
